(19) United States
(12) Patent Application Publication
(10) Pub. No.: US 2025/0377245 A1
(43) Pub. Date: Dec. 11, 2025

(54) THERMOCOUPLE HARNESSES FOR SOLID OXIDE ELECTROCHEMICAL SYSTEMS

(71) Applicant: Bloom Energy Corporation, San Jose, CA (US)

(72) Inventors: Vivek Singh, Bangalore (IN); Michael Petrucha, Los Gatos, CA (US); Kyle Kekelis, San Jose, CA (US); James Huynh, San Jose, CA (US); Aidan James Leitch, Mountain View, CA (US)

(21) Appl. No.: 19/229,823

(22) Filed: Jun. 5, 2025

Related U.S. Application Data
(60) Provisional application No. 63/656,444, filed on Jun. 5, 2024.

(51) Int. Cl. G01K 1/14; C25B 1/042; C25B 15/023; G01K 1/08; G01K 7/04; H01M 8/04007

(52) U.S. Cl. CPC G01K 1/14; C25B 1/042; C25B 15/023; G01K 1/08; G01K 7/04; H01M 8/04067

(57) ABSTRACT

Hermetic thermocouple harnesses for solid oxide electrochemical systems include a harness having a feedthrough washer including two metal disks with holes circumferentially disposed about the disks and a braze alloy layer between the disks. Thermocouples are fed through the feedthrough washer, and induction brazing is used to seal and bind the disks and the thermocouples together. The feedthrough washer is welded to the base of the hotbox, forming a hermetic seal while allowing the thermocouples to extend between the interior and exterior of the hotbox. A second harness includes a main body, a top tube, and a sealant end having holes. Thermocouples extend from the interior of the hotbox, through the top tube, main body, and through the holes of the sealant to the exterior of the hotbox. Clearance between the thermocouples and their respective holes are closed with glass seals, and the top tube is filled with putty.

### CROSS REFERENCE TO RELATED APPLICATIONS

This application claims priority to and the benefit of U.S. Provisional Patent Application No. 63/656,444, filed Jun. 5, 2024, titled “THERMOCOUPLE HARNESS FOR SOLID OXIDE FUEL SYSTEM,” the contents of which is incorporated by reference in its entirety for all purposes.

### BACKGROUND

Solid oxide electrochemical systems include solid oxide fuel cell (SOFC) systems and solid oxide electrolyzer cell (SOEC) systems. SOFC systems provide sustainable, resilient power. SOEC systems generate hydrogen from electrolysis of steam. Both systems operate at high temperatures (e.g., 850° C.) and typically include a “hotbox” housing fuel cells where exothermic reactions involving process gases occur. Various sensor readings (e.g., temperature, and the like) are used to monitor the health and behavior of the hotbox and the fuel cells inside of the hotbox. For example, thermocouples can be used to take temperature measurements inside of the hotbox. If the sensing junction or sensing point of a thermocouple is located inside of a hotbox next to the fuel cell stacks, thermocouple wires must extend from the sensing junction or sensing point within the hotbox to monitoring or sensing equipment located outside of the hotbox. The path through which the thermocouple wires extend provides a point from which heat and gases can leak from the hotbox. Such heat and gas leaks are undesirable because they may damage components near the hotbox, may cause thermal imbalance inside the hotbox, and may cause other health and safety issues. Accordingly, improved systems and methods are needed for routing thermocouple wires in and out of hotboxes.

### SUMMARY

To address the issues described above, described herein are thermocouple harnesses including heat sealing and hermetic characteristics for use in solid oxide electrochemical systems and associated methods for manufacturing and assembling the harnesses for use with such systems.

One general aspect includes a thermocouple harness for a hotbox of a solid oxide electrochemical system. The thermocouple harness includes a number of thermocouples and a feedthrough washer including two metal disks. Each metal disk includes the same number of holes as there are thermocouples, and the holes are disposed on the metal disk extending from the first flat surface to the second flat surface of the metal disk. Each hole has a diameter sized to within a tolerance of the diameter of one of the thermocouples. A thermocouple is fed through each of the holes. The two metal disks are coupled together and to the thermocouples with a braze alloy disposed between the two metal disks. The feedthrough washer is configured to be mechanically coupled to the interior edge of a base of the hotbox such that one end of the thermocouples is disposed within the hotbox.

Implementations of the first aspect may include one or more of the following features. Optionally, the braze alloy layer may include two or more layers of high temperature braze foil. Optionally, the solid oxide electrochemical system is either a solid oxide fuel cell system configured to generate electricity or a solid oxide electrolyzer cell system configured to generate a hydrogen product from electrolysis of steam. Optionally, the two metal disks are coupled together and to the number of thermocouples using induction brazing.

A second general aspect includes a method for sealing a thermocouple harness for a hotbox of a solid oxide electrochemical system. The method includes feeding a number of thermocouples through holes in a feedthrough washer, where the feedthrough washer includes two metal disks and a braze alloy layer disposed between the two metal disks. Each metal disk includes a hole for each thermocouple circumferentially disposed about the metal disk and extending from a first flat surface of the metal disk to a second flat surface of the metal disk. Each hole has a diameter sized to within a tolerance of a diameter of a thermocouple. The method further includes induction brazing the two metal disks together using the braze alloy layer to seal and bind a length of the thermocouples extending through the feedthrough washer to the two metal disks.

Implementations of the second general aspect may include one or more of the following features. Optionally, the method may further include welding the feedthrough washer to an interior edge of a base of the hotbox such that a first end of the thermocouples is disposed within the hotbox. Optionally, the induction brazing may include placing the feedthrough washer with the thermocouples disposed within the holes of the metal disks in a brazing jar and supplying a gas to the brazing jar. The method further includes wrapping an induction coil around the brazing jar and applying current to the induction coil.

A third general aspect includes a thermocouple harness that includes a hollow, cylindrical main body through which the thermocouple wires extend. At one end of the main body, a top tube is coupled to the main body, which in turn is coupled to a base portion of a solid oxide electrochemical system hotbox. The top tube is filled with putty and surrounds the thermocouple wires extending through the top tube. The thermocouple wires extend into the hotbox, and the putty creates a heat reducing seal between a high temperature region of the hotbox and the main body of the thermocouple harness. At the other end of the main body, a cylindrical sealant is coupled that includes grooves on either side of a central portion through which holes extend, and thermocouple wires extend through the holes to the exterior of the hotbox. Clearance between the thermocouple wires and their respective holes are sealed to prevent both heat loss and leakage from the hotbox. For example, the clearance may be filled with a glass-based sealant to form a hermetic seal.

Implementations of the third general aspect may include one or more of the following features. Optionally, the seals are glass seals. Optionally, the main body may include a bellow. Optionally, the thermocouple harness includes a strain relief washer including a disk having holes, where the strain relief washer is disposed within the front groove of the cylindrical sealant, the holes align with the holes of the cylindrical sealant, and each thermocouple extending through the holes of the cylindrical sealant extends through a corresponding hole of the strain relief washer. Optionally, the strain relief washer is configured to be restricted to linear movement along an axis through a center of the front groove of the cylindrical sealant. Optionally, the top tube and the main body are each made of a heat-resistant alloy. Optionally, each hole of the cylindrical sealant has a hole diameter sized to a diameter of a thermocouple of the plurality of thermocouples and a clearance, and each of the seals is configured to fill the clearance of the hole diameter at a first side of the hole disposed at the back groove and at a second side of the hole disposed at the front groove. Optionally, the length of the front groove of the cylindrical sealant, the length of the back groove of the cylindrical sealant, and the length of the central portion of the cylindrical sealant are substantially the same. Optionally, the length of the back groove of the cylindrical sealant mitigates heat exposure at the seals during the coupling process that couples the first end of the cylindrical sealant to the second end of the main body such that the seals are not structurally compromised by the coupling process. Optionally, a length of the front groove of the cylindrical sealant is selected to limit an available bending angle of each of the plurality of thermocouples at the corresponding seal to a threshold angle. Optionally, the putty may include one of at least ninety percent (90%) alumina or a magnesium oxide base. Optionally, the distance between each pair of the holes in the cylindrical sealant is at least two times the diameter of one hole. Optionally, the solid oxide electrochemical system may be a solid oxide fuel cell system configured to generate electricity or a solid oxide electrolyzer cell system configured to generate a hydrogen product from electrolysis of steam.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations are described with reference to the following drawings.

FIG. 1 illustrates a thermocouple harness, according to various embodiments of the present disclosure.

FIG. 2 illustrates an exploded view of the thermocouple harness of FIG. 1, according to various embodiments of the present disclosure.

FIG. 3 illustrates a cross-sectional view of the thermocouple harness of FIG. 1, according to various embodiments of the present disclosure.

FIGS. 4A and 4B illustrate perspective views of a cylindrical sealant of the thermocouple harness of FIG. 1, according to various embodiments of the present disclosure.

FIG. 5A illustrates an optional strain relief washer of the thermocouple harness of FIG. 1, according to various embodiments of the present disclosure.

FIG. 5B illustrates a cross-sectional view of a cylindrical sealant and an optional strain relief washer of FIG. 5A, according to various embodiments of the present disclosure.

FIG. 6 illustrates a hotbox base with multiple thermocouple harnesses of FIG. 1 incorporated, according to various embodiments of the present disclosure.

FIG. 7 illustrates a side view of the hotbox base of FIG. 6, according to various embodiments of the present disclosure.

FIG. 8 illustrates another view of the hotbox base of FIG. 6 with enlarged portions, according to various embodiments of the present disclosure.

FIG. 9 illustrates a cross-sectional view of the hotbox base of FIG. 6 with an enlarged portion, according to various embodiments of the present disclosure.

FIG. 10 illustrates a step of assembling the thermocouple harness of FIG. 1, according to various embodiments of the present disclosure.

FIG. 11 illustrates another step of assembling the thermocouple harness of FIG. 1, according to various embodiments of the present disclosure.

FIG. 12 illustrates yet another step of assembling the thermocouple harness of FIG. 1, according to various embodiments of the present disclosure.

FIG. 13 illustrates yet another step of assembling the thermocouple harness of FIG. 1, according to various embodiments of the present disclosure.

FIG. 14 illustrates an alternative embodiment of a thermocouple harness having bellows in the main body, according to various embodiments of the present disclosure.

FIGS. 15A and 15B illustrate another thermocouple harness, according to various embodiments of the present disclosure.

FIG. 16 illustrates a brazing technique for sealing the thermocouple harness of FIGS. 15A and 15B, according to various embodiments of the present disclosure.

FIG. 17A illustrates a hotbox base with multiple thermocouple harnesses of FIG. 15B incorporated, according to various embodiments of the present disclosure.

FIG. 17B illustrates a perspective view of the hotbox base of FIG. 17A, according to various embodiments of the present disclosure.

FIG. 18 illustrates a method for manufacturing the thermocouple harness of FIG. 15B, according to various embodiments of the present disclosure.

FIG. 19 illustrates a schematic of a SOFC system, according to various embodiments of the present disclosure.

FIG. 20A illustrates a sectional view showing components of a hotbox of the system of FIG. 19, according to various embodiments of the present disclosure.

FIG. 20B illustrates an enlarged portion of some hotbox components of FIG. 20A, according to various embodiments of the present disclosure.

FIG. 20C illustrates a three-dimensional cut-away view of a central column of a hotbox of FIG. 20A, according to various embodiments of the present disclosure.

FIG. 20D illustrates a perspective view of an anode hub structure disposed below the central column of the hotbox of FIG. 20A, according to various embodiments of the present disclosure.

FIGS. 21A-21C illustrate sectional views showing fuel and air flow through the central column of the hotbox of FIG. 20A, according to various embodiments of the present disclosure.

FIG. 22 is a perspective view of an exemplary modular SOFC system, according to various embodiments of the present disclosure.

### DETAILED DESCRIPTION

Various exothermic reactions involving process gases create high temperatures inside of a solid oxide electrochemical system hotbox. Thermocouple devices are used to measure the temperature of components residing inside the hotbox for purposes of monitoring and controlling the operation of the solid oxide electrochemical system. Wire leads need to connect the sensing junction or sensing point of a thermocouple inside of the hotbox to measuring or monitoring equipment located outside of the hotbox. Heat and gases may leak through any unsealed point where the thermocouple wires pass through the hotbox housing.

To address these issues, improved thermocouple harnesses and methods of manufacture are disclosed. Enclosing the thermocouple wires within a thermocouple harness as described throughout this disclosure and sealing the connection of the thermocouple harness at the entry to the hotbox reduces heat loss and gasses from escaping the hotbox. Sealing the hotbox at the point where the thermocouple leads exit the hotbox housing limits heat loss, which increases hotbox life by reducing oxidation of the stack support base. Such scaling improves efficiency of the hotbox and mitigates heat and gas-related damage to surrounding equipment and people.

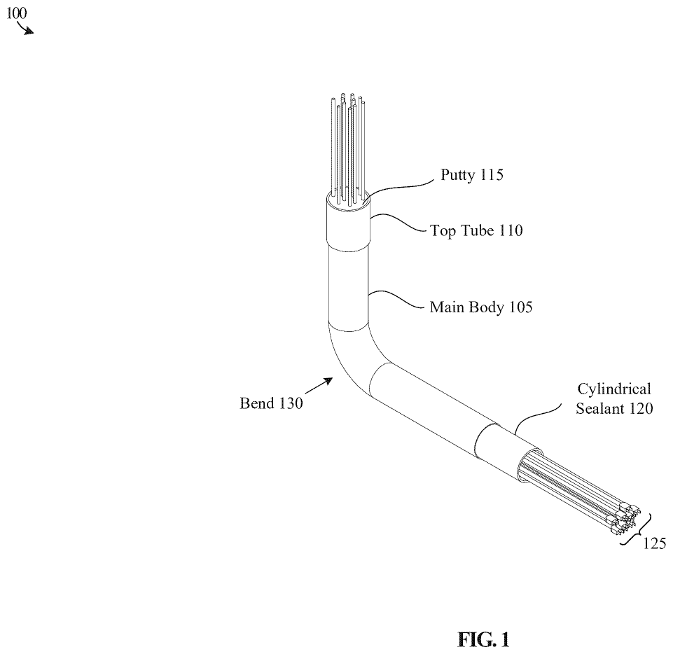

Turning now to FIG. 1, a thermocouple harness 100 according to various embodiments of the present disclosure is illustrated. Thermocouple harness 100 includes main body 105, top tube 110, putty 115, and cylindrical sealant 120. A thermocouple device is comprised of several components including at least a hot junction (also referred to as a sensing junction or sensing point), a cold junction, and a pair of dissimilar metal wire leads connecting those junctions. As used throughout this disclosure, thermocouple 125 collectively refers to one or more of these components that comprises a thermocouple device. Thermocouple 125 may also be called thermocouple wire, thermocouple wires, or thermocouples, all of which mean one or more of a thermocouple device.

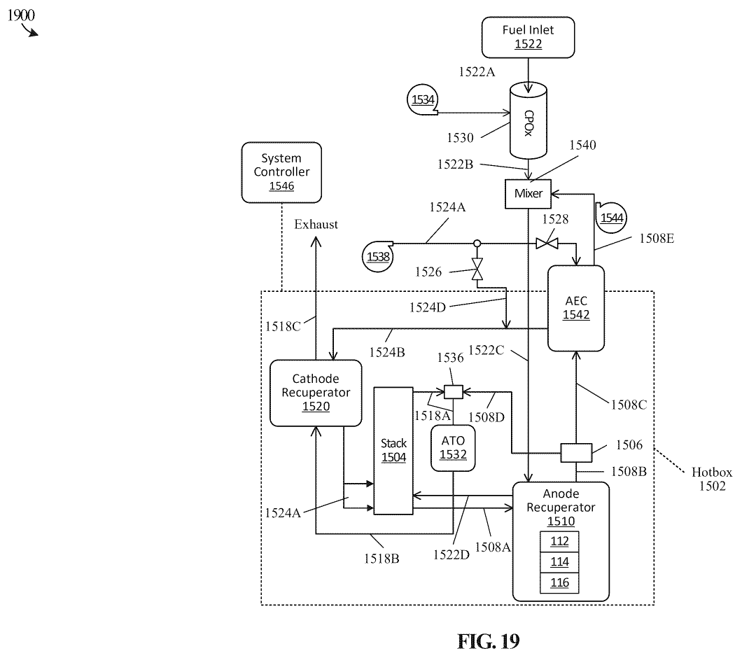

Thermocouple harness 100 is designed for wide-ranging temperature applications such as those associated with a hotbox of a solid oxide electrochemical system (e.g., hotbox 1502 described with respect to FIGS. 19-22). For example, temperatures within the hotbox may exceed 850° C. while temperatures outside of the hotbox may be only room temperature (e.g., 20° C.). In some installation sites, a solid oxide electrochemical system may be in a cold-weather environment, such that the exterior of the hotbox may be exposed to sub-zero temperatures (e.g., −20° C.). To account for these temperature differences, main body 105 of thermocouple harness 100 may be formed from a heat-resistant alloy to ensure structural stability despite exposure to the varying conditions discussed above. For example, the alloy may be SS310/IN625/IN600, though any suitable heat-resistant alloy may be used.

Thermocouple harness 100 includes top tube 110 coupled to main body 105 at one end, and cylindrical sealant 120 coupled to the other end of main body 105. Main body 105 may be joined with top tube 110 and cylindrical sealant 120, for example, by welding, brazing, soldering, or the like. However, any mechanical coupling process that ensures the entire joint at each end of main body 105 is sealed may be used. Main body 105 is a tube (i.e., a hollow cylinder), though in some embodiments other shapes may be used. Main body 105 is hollow, and thermocouples 125 are fed through main body 105 as shown throughout this disclosure. Main body 105 may include one or more bends 130 between the first end (coupled to top tube 110) and the second end (coupled to cylindrical sealant 120). Main body 105 as shown in FIG. 1 includes one bend 130. However, any number and angle of bends suitable for routing thermocouples 125 between temperature measurement locations inside of the hotbox and the exterior of the hotbox may be utilized. For example, bend 130 may be an angle of one degree to ninety degrees (1-90 degrees). In some embodiments, main body 105 is rigid. For example, the thickness of the wall of main body 105 may be thick enough to resist easily changing the angle of bend 130 or bending straight portions of main body 105. In other embodiments, main body 105 is flexible. For example, the thickness of the wall of main body 105 may be thin enough to easily change the angle of bend 130 or bending straight portions of main body 105. In some embodiments, portions of main body 105 are rigid and other portions of main body 105 are flexible. The diameter of the hollow portion of main body 105 may be any diameter suitable for routing thermocouple wires 125. Accordingly, the diameter may depend on the number of thermocouples 125 needed. For example, the hollow portion of main body 105 may be 15 mm to 100 mm, in some embodiments. The diameter of main body 105 may be any diameter suitable for ensuring the rigidity or flexibility desired for main body 105 based on the diameter of the hollow portion. For example, the diameter of main body 105 may be 20 mm to 150 mm, in some embodiments.

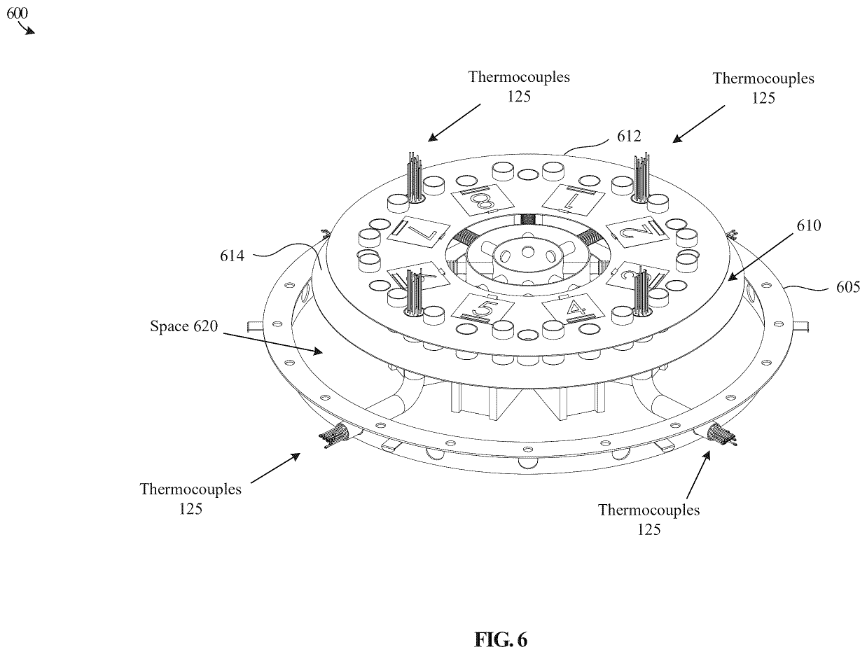

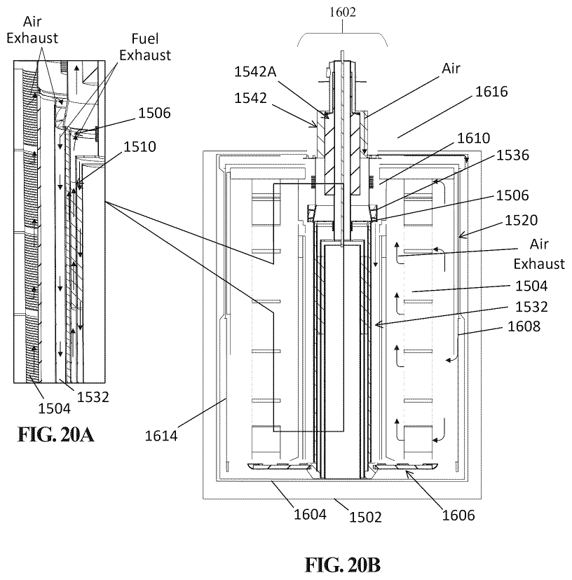

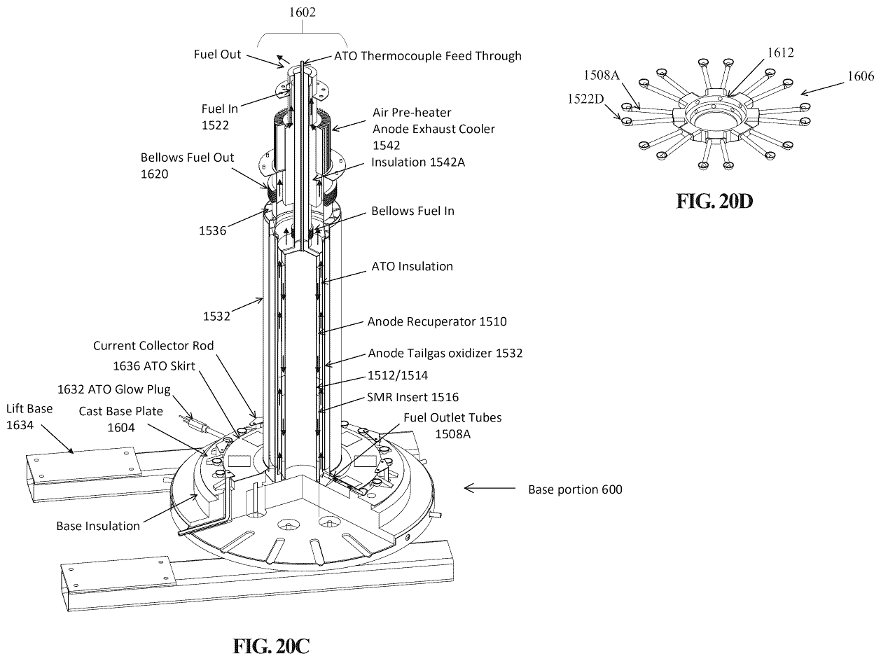

The end of main body 105 joined with top tube 110 may experience very high temperatures due to the proximity of top tube 110 to heated air in the hotbox, the fuel cell stacks inside of the hotbox, and the flow of ATO exhaust around the top tube 110. The end of main body 105 joined with cylindrical sealant 120 may experience much lower temperatures due to its proximity to the exterior of the hotbox. Top tube 110 may be formed from a heat-resistant alloy to ensure structural stability given exposure to the high temperature conditions within the hotbox. For example, the alloy may be SS310/IN625/IN600, though any suitable heat-resistant alloy may be used. In some embodiments, top tube 110 and main body 105 are formed from the same alloy, and in other embodiments different alloys are used for each. However, alloys for each may be chosen based at least partially on thermal expansion properties of the alloy to ensure that temperature fluctuations do not compromise the joint at which main body 105 and top tube 110 are coupled. For example, materials used for main body 105 and top tube 110 may have a similar coefficient of thermal expansion. Further, top tube 110 is coupled to the anode tail gas oxidizer (ATO) skirt (e.g., ATO skirt 610 as described with respect to FIG. 6, ATO skirt 1636 as described with respect to FIG. 20C) in the hotbox base (e.g., hotbox base 600, hotbox base 1604). Top tube 110 is a tube (i.e., a hollow cylinder) as shown in FIG. 1, though top tube 110 may be any suitable shape. The shape of top tube 110 corresponds or is the same as the shape of main body 105. For example, both are tubes as shown in FIG. 1. Top tube 110 is hollow, and thermocouple wires 125 are fed through top tube 110 as shown throughout this disclosure. The diameter of the hollow portion of top tube 110 is designed and selected to ensure top tube 110 can slide over the end of main body 105. For example, the diameter of the hollow portion of top tube 110 may be 1 mm to 5 mm larger than the diameter of main body 105. The length of top tube 110 may be selected to ensure putty 115 that fills the space within top tube 110 forms a heat reducing seal. To ensure the heat reduction is sufficient, the length of top tube 110 may be increased. In some embodiments, the length of top tube 110 may be the distance between the top plate (e.g., top plate 612) and the bottom plate (e.g., bottom plate 614) of the ATO skirt (e.g., ATO skirt 610).

Putty 115 fills the space within top tube 110 and surrounds thermocouple wires 125 passing through top tube 110. Putty 115 forms a seal at top tube 110. Accordingly, putty 115 inhibits heated gases inside the hotbox from flowing into the hollow portion of main body 105 and reduces heat transfer. In other words, putty 115 forms a heat reducing seal inhibiting the flow of hot air above the ATO skirt into the hollow portion of main body 105. As such, the temperature inside main body 105 is substantially less than the temperature of the heated air above top plate 612 inside the hotbox. As one example, the hot air inside the hotbox may be 800° C. while the temperature within main body 105 is 400° C. Accordingly, thermocouple harness 100 reduces heat leak from the interior of the hotbox to the exterior of the hotbox.

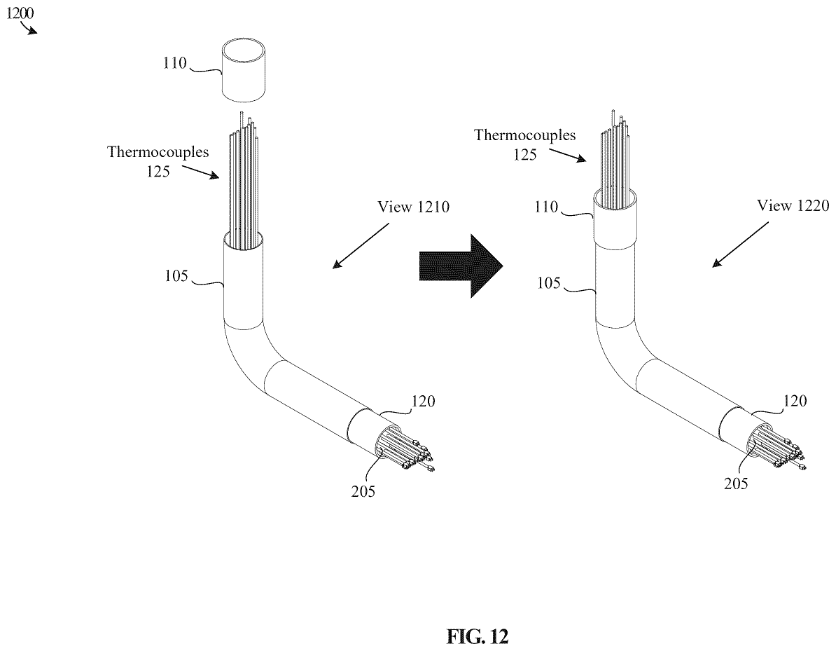

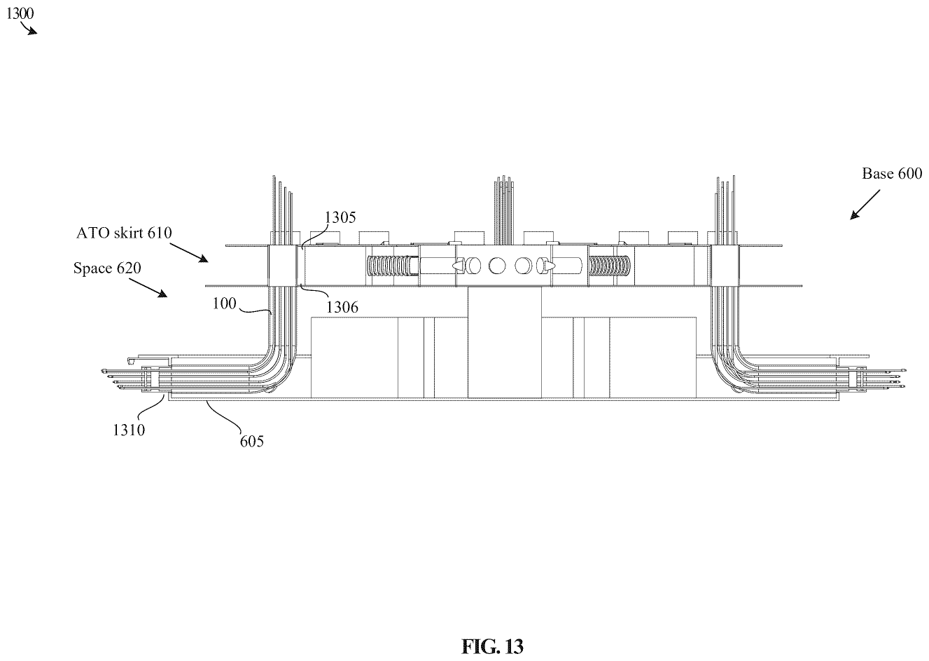

Putty 115 may be any suitable putty including, for example alumina putty or putty having a magnesium oxide (MgO) base. Alumina putty may be ninety percent (90%) alumina or more (e.g., 99% alumina, 96% alumina, or the like). Putty 115 may be injected into top tube 110 during manufacturing of the thermocouple harness as discussed in more detail with respect to FIGS. 12 and 13.

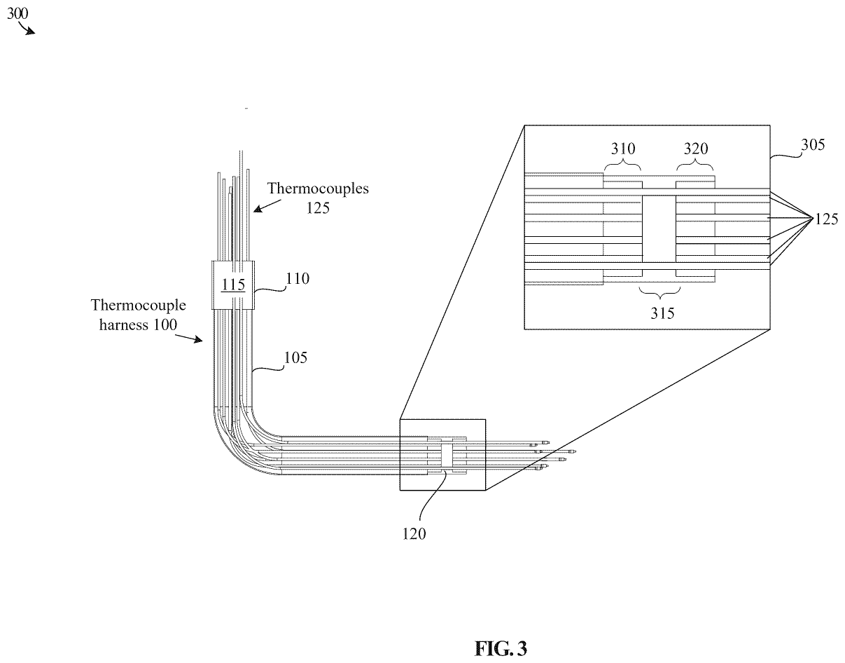

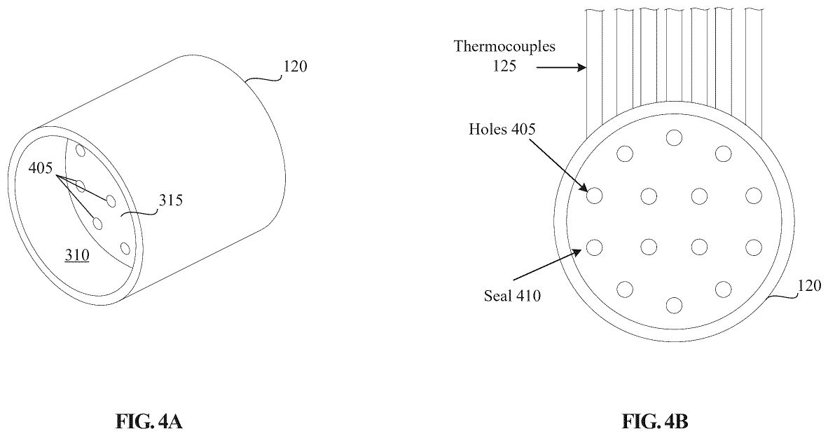

Cylindrical sealant 120 may be formed from a heat-resistant alloy to ensure structural stability despite exposure to the extreme conditions described above, including the difference in temperature between the exterior of the hotbox and main body 105. For example, the alloy used for cylindrical sealant 120 may be SS310/IN625/IN600, though any suitable heat-resistant alloy may be used. In some embodiments, cylindrical sealant 120 and main body 105 are formed from the same alloy, and in other embodiments different alloys are used for each. However, alloys for each may be chosen based at least partially on thermal expansion properties of the alloy to ensure that temperature fluctuations do not compromise the joint at which main body 105 and cylindrical sealant 120 are coupled. For example, materials used for main body 105 and cylindrical sealant 120 may have a similar coefficient of thermal expansion. Further, cylindrical sealant 120 is coupled to the free flow pan (e.g., free flow pan 605 as described with respect to FIG. 6) in the hotbox base (e.g., hotbox base 600, hotbox base 1604). Cylindrical sealant 120 may be a cylindrical shape as shown in FIG. 1, though cylindrical sealant 120 may be any suitable shape. The shape of cylindrical sealant 120 is the same as or corresponds to the shape of main body 105. For example, both are cylindrical as shown in FIG. 1. Cylindrical sealant 120 may be, for example, machined from a solid rod. The diameter of cylindrical sealant 120 is designed and selected to ensure that the end of main body 105 can slide over the end of cylindrical sealant 120. For example, the diameter of cylindrical sealant 120 may be 1 mm to 5 mm smaller than the diameter of the hollow portion of main body 105. Details of cylindrical sealant 120 are described in further detail with respect to FIGS. 3, 4A, and 4B.

Thermocouples 125 may be any type of thermocouple that is suitable for use in the temperature conditions described above. While a certain number of thermocouples 125 are illustrated in the Figures, this disclosure is not limited to a specific number of thermocouples (i.e., more or less thermocouples 125 may be routed through each thermocouple harness 100).

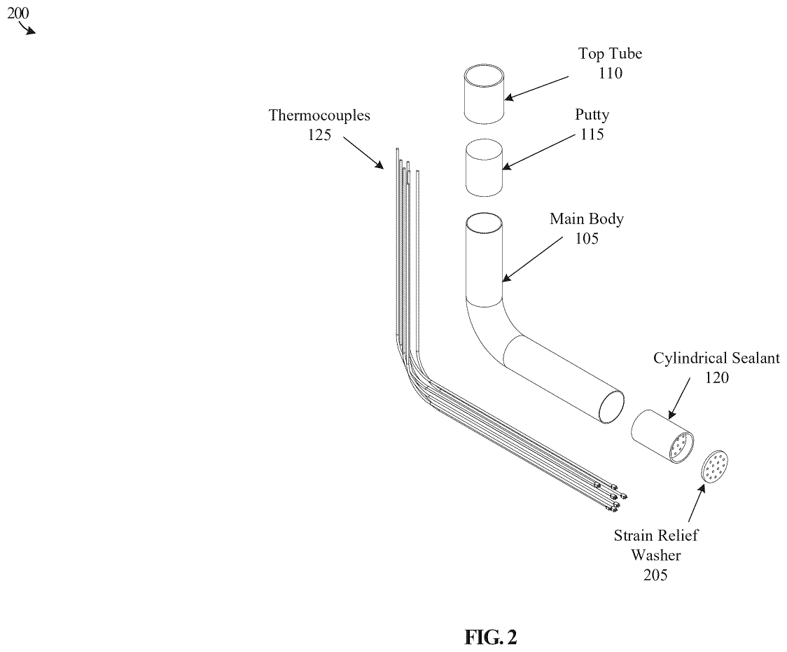

FIG. 2 illustrates an exploded view 200 of thermocouple harness 100, according to various embodiments of the present disclosure. Exploded view 200 illustrates that thermocouple wires 125 are continuous lengths that are routed through thermocouple harness 100 and are disposed within thermocouple harness 100 when fully assembled. Further, as described above with respect to FIG. 1, top tube 110 slides over the end of main body 105, and putty 115 fills top tube 110, creating a heat-resistant seal around the portion of thermocouples 125 extending out of thermocouple harness 100 into the high temperature areas of the hotbox.

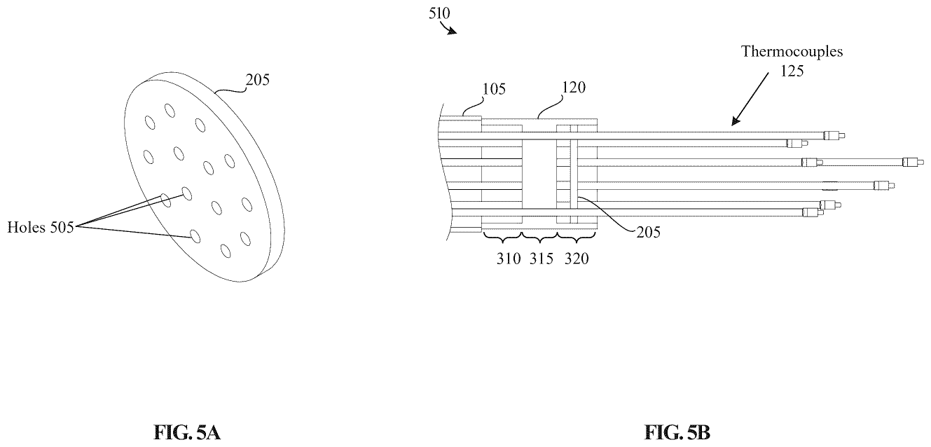

Exploded view 200 further shows that main body 105 slides over cylindrical sealant 120. Exploded view 200 further includes an optional strain relief washer 205. Strain relief washer 205 is placed within a front groove (e.g., front groove 320 described with respect to FIG. 3) of cylindrical sealant 120. Strain relief washer 205 may be disk shaped and have a diameter smaller than the diameter of the front groove. For example, the diameter of strain relief washer 205 may be 1 mm to 3 mm smaller than the diameter of the front groove. Further details of strain relief washer are provided in connection with FIG. 5.

FIG. 3 illustrates a cross-sectional view 300 of thermocouple harness 100, according to various embodiments of the present disclosure. Cross-sectional view 300 includes enlarged view 305 of cylindrical sealant 120. As illustrated, cylindrical sealant 120 includes a back groove 310, central portion 315, and front groove 320. Back groove 310 has a length corresponding to the shortest distance between the edge of cylindrical sealant 120 and the edge of central portion 315. The length of back groove 310 may be designed and selected to ensure that heat produced from the joining process (e.g., by welding, brazing, soldering, or the like) that joins main body 105 and cylindrical sealant 120 does not compromise the structural stability of seals (e.g., seals 410) formed at central portion 315. The seals are described in more detail with respect to FIG. 4B.

Central portion 315 includes holes (e.g., holes 405) that extend through the length of central portion 315 for routing thermocouple wires 125 therethrough (i.e., thermocouple wires 125 that extend from within main body 105 through cylindrical sealant 120 to the exterior of the hotbox). The holes are described in more detail with respect to FIGS. 4A and 4B. Central portion 315 has a length, which is the shortest distance between the edge of back groove 310 and the edge of front groove 320.

Front groove 320 has a length corresponding to the shortest distance between the edge of cylindrical sealant 120 and the edge of central portion 315. The length of front groove 320 may be designed and selected to reduce strain on the seals formed in central portion 315. More specifically, thermocouple wires 125 may bend as they extend out of thermocouple harness 100 from the front groove 320 of cylindrical sealant 120. Front groove 320 limits the angle at which thermocouple wires 125 may bend at the point thermocouple wires 125 exit the holes 405 in central portion 315. A larger angle bend creates a larger strain at the bend point on the seals of the holes 405 in central portion 315, so limiting the angle of bending reduces the strain at that point and on the seals. Additionally, the length of front groove 320 may be designed and selected to ensure that heat produced from the joining process (e.g., by welding, brazing, soldering, or the like) that joins cylindrical sealant 120 to free flow pan 605 does not compromise the structural stability of seals (e.g., seals 410) formed at central portion 315. The seals are described in more detail with respect to FIG. 4B.

In some embodiments, the lengths of each of the front groove 320, the central portion 315, and the back groove 310 may be substantially the same, and in some embodiments different lengths may be used for each. In some embodiments, the length of each may be between 5 mm and 15 mm.

FIGS. 4A and 4B illustrate perspective views of cylindrical sealant 120 of thermocouple harness 100, according to various embodiments of the present disclosure. Holes 405 are machined through central portion 315 of cylindrical sealant 120. One hole 405 is machined for each thermocouple 125 being routed through thermocouple harness 100. Each hole 405 has a diameter sufficient to allow one thermocouple 125 to pass through it. Accordingly, the diameter of the holes 405 may be the diameter of one thermocouple 125 plus a clearance amount. The clearance amount may be, for example, up to 100 microns. Holes 405 may be uniformly distributed across central portion 315 in some embodiments. The distance between each hole 405 may be selected to help ensure sufficient wall strength of central portion 315 so that there is no distortion of the holes 405 or central portion 315 during or after the drilling process to create the holes 405. For example, a distance between each hole 405 may be twice the diameter of holes 405 (e.g., if the hole diameter is 2 mm, the minimum distance between each hole is 4 mm).

To ensure the interior of main body 105 is sealed from the exterior of the hotbox by cylindrical sealant 120, seals 410 are formed at each hole 405 in the clearance space around thermocouples 125. The seals 410 may be formed from glass (e.g., an amorphous glass structure) in some embodiments. The material used for seals 410 may be stable in an oxidizing environment with temperatures up to an upper limit of the temperature expected in main body 105. As one example, temperatures in main body 105 may be expected to reach approximately 400° C., so seals 410 may be stable in an oxidizing environment up to 600° C. to account for unexpectedly high temperatures. The material used for seals 410 may have sufficient ductility to resist physical forces exerted by bending and movement of thermocouples 125 including during the assembly process (e.g., assembly of the thermocouple harness 100 and installation within the hotbox base (e.g., hotbox base 600)). Seals 410 may be created by, for example, sintering the material used for the seals 410. Each seal 410 forms a seal around each thermocouple 125 and the corresponding hole 405. A fillet seal may be formed at each edge of central portion 315 about each thermocouple 125 at its corresponding hole 405. Further, in some embodiments, seal 410 may fill the clearance within each hole 405 across the length of central portion 315. In some embodiments, seal 410 may not extend across the entire length of central portion 315. Instead, seal 410 may be formed at one or both edges of central portion 315 and extend some distance of the length of central portion 315, filling the clearance for at least a portion of the length of central portion 315.

The seal formed by cylindrical sealant 120 inhibits the flow of gases inside of main body 105 to the exterior of the hotbox through thermocouple harness 100.

FIG. 5A illustrates an optional strain relief washer 205 of thermocouple harness 100, according to various embodiments of the present disclosure. Strain relief washer 205 may be formed from a heat-resistant alloy, a stainless-steel alloy, or the like, and may be the same material used for cylindrical sealant 120. The material used for strain relief washer 205 may be selected to ensure a similar coefficient of thermal expansion similar to that of cylindrical sealant 120. Holes 505 are formed in strain relief washer 205 that correspond to holes 405 in central portion 315 of cylindrical sealant 120. In other words, each hole 505 is positioned in strain relief washer 205 to align with a corresponding hole 405 in central portion 315.

FIG. 5B illustrates a cross-sectional view 510 of cylindrical sealant 120 and optional strain relief washer 205 of thermocouple harness 100, according to various embodiments of the present disclosure. As shown, strain relief washer 205 may be positioned within front groove 320 of cylindrical sealant 120. A thermocouple 125 is fed through each hole 505 and its corresponding hole 405. Strain relief washer 205 may provide additional strain relief for seals 410 because thermocouples 125 cannot be bent at the seal 410 as they are held in position by strain relief washer 205. Strain relief washer 205 may have two degrees of movement such that it can slide along the length of front groove 320. Strain relief washer 205 may be configured to stop or limit movement in any other direction (e.g., rotational movement). In some embodiments, strain relief washer 205 may include a tab (not shown) that fits within a groove formed in front groove 320 extending the length of front groove 320 to stop rotational movement while allowing linear movement of strain relief washer 205 within front groove 320.

FIG. 6 illustrates hotbox base 600 with multiple thermocouple harnesses 100 incorporated and assembled, according to various embodiments of the present disclosure. Hotbox base 600 includes four thermocouple harnesses 100, however a larger or smaller number of thermocouple harnesses 100 may be included in hotbox base 600. Hotbox base 600 includes free flow pan 605, anode tail gas oxidizer (ATO) skirt 610 (comprising top plate 612 and bottom plate 614), and space 620.

One or more fuel cell columns may be placed above top plate 612 of ATO skirt 610. FIG. 6 illustrates locations for eight fuel cell columns, though a larger or smaller number of fuel cell columns may be used. Details of the hotbox are further described in FIGS. 19-22. Accordingly, the portions of thermocouples 125 that extend out of the top tube 110 of each thermocouple harness 100 at ATO skirt 610 extend into high temperature regions of the hotbox. Top tube 110 of each thermocouple harness 100 is mechanically joined (e.g., by welding, brazing, soldering, or the like) to ATO skirt 610. The joint at which top tube 110 is coupled to ATO skirt 610 is sealed, for example by welding, around the entire circumference of top tube 110. For example, top tube 110 may be joined to top plate 612 and bottom plate 614 by welding around the entire circumference of top tube 110 such that a gas tight seal is formed to avoid heated air above the top plate 612 from mixing with ATO exhaust flowing between top plate 612 and bottom plate 614.

Free flow pan 605 forms an exterior edge of hotbox base 600 such that where thermocouples 125 extend out of free flow pan 605, they extend to the exterior of the hotbox. Free flow pan 605 is pan shaped, having a flat surface forming the bottom of hotbox base 600 and having a wall portion that extends substantially perpendicularly from the flat surface the entire distance around the flat surface to create a partially enclosed area as shown in FIG. 6. Cylindrical sealant 120 of each thermocouple harness 100 is mechanically joined (e.g., by welding, brazing, soldering, or the like) to the wall of free flow pan 605. The joint at which cylindrical sealant 120 is coupled to free flow pan 605 is sealed, for example by welding, around the entire circumference of cylindrical sealant 120. For example, cylindrical sealant 120 may be joined to the wall of free flow pan 605 by welding around the entire circumference of cylindrical sealant 120 such that a seal (e.g., hermetic seal) is formed to avoid leakage from space 620 to the exterior of the hotbox (i.e., outside the hotbox). Space 620 represents the space between bottom plate 614 of ATO skirt 610 and the flat surface of free flow pan 605. Thermocouple harnesses 100 are routed through space 620. In some embodiments, space 620 may be filled with insulation such that insulation surrounds thermocouple harnesses 100 that are routed through space 620.

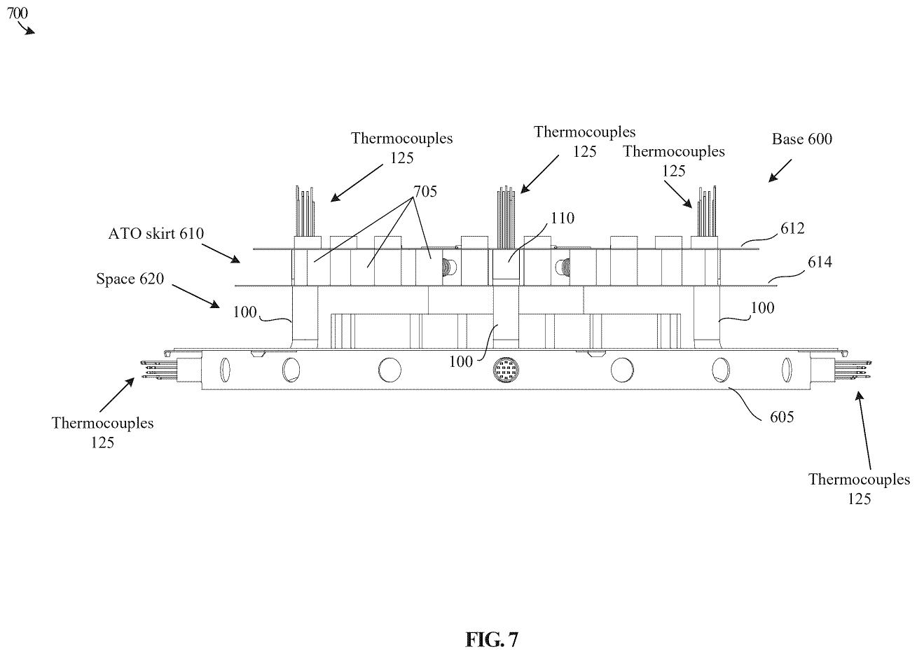

FIG. 7 illustrates a side view 700 of hotbox base 600 incorporating multiple thermocouple harnesses 100, according to various embodiments of the present disclosure. From side view 700, the distance between top plate 612 to bottom plate 614 is more readily apparent. In some embodiments, top tube 110 may be the height of the distance between top plate 612 and bottom plate 614, and top tube 110 may be joined (e.g., by welding, brazing, soldering, or the like) to both top plate 612 and bottom plate 614 to seal both locations.

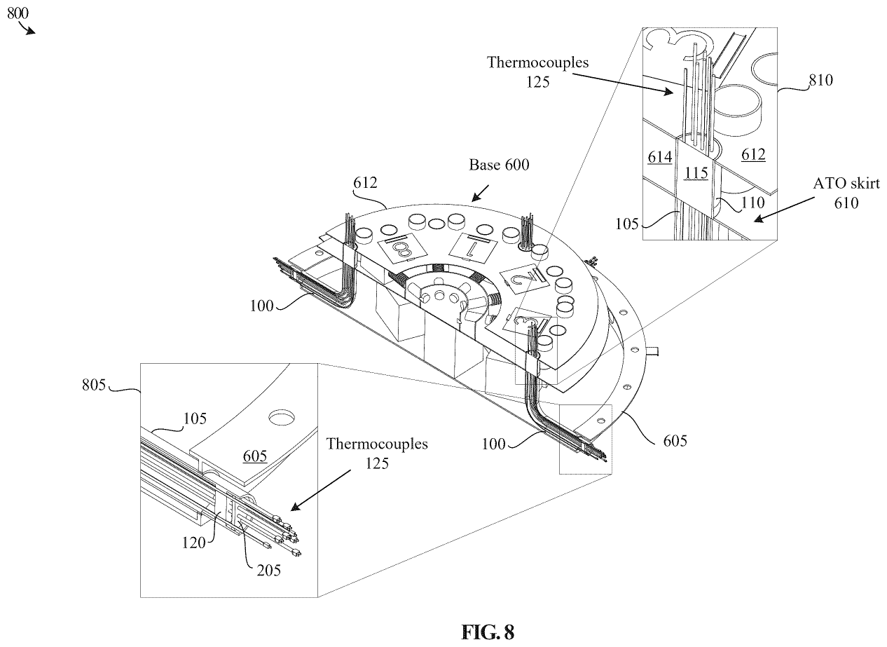

FIG. 8 illustrates a cross-sectional view 800 of hotbox base 600 with enlarged portion 805 and enlarged portion 810, according to various embodiments of the present disclosure. From cross-sectional view 800, the path made by thermocouple harnesses 100 through space 620 of base 600 is easily visible.

Enlarged portion 805 illustrates that cylindrical sealant 120 is joined (e.g., by welding, brazing, soldering, or the like) to the wall of free flow pan 605. Further, strain relief washer 205 may be positioned within front groove 320 of cylindrical sealant 120 at the joint. In this way, strain relief washer 205 may provide support to avoid crushing or distorting the shape of cylindrical sealant 120 along front groove 320 from forces exerted on or by free flow pan 605.

Enlarged portion 810 illustrates that, when assembled, top tube 110 spans the distance between top plate 612 and bottom plate 614 of ATO skirt 610. Further, putty 115 fills the space within top tube 110 and surrounds the thermocouples 125.

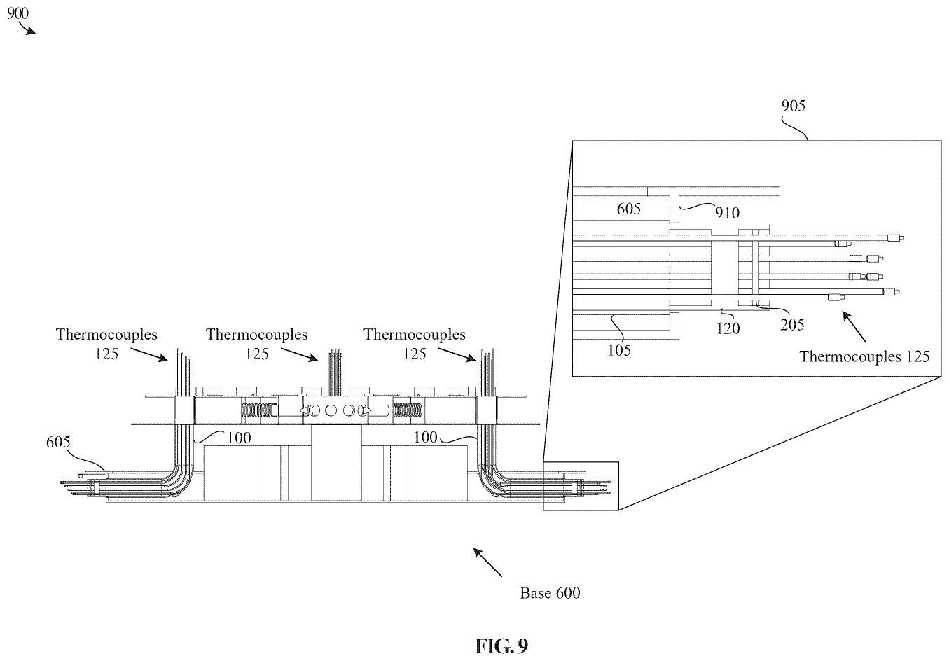

FIG. 9 illustrates a cross-sectional view 900 of hotbox base 600 with an enlarged portion 905, according to various embodiments of the present disclosure. Enlarged portion 905 shows wall 910 of free flow pan 605 to which cylindrical sealant 120 is mechanically joined. Strain relief washer 205 is positioned such that it is aligned with wall 910 to provide support within front groove 320 of cylindrical sealant 120. Further, strain relief washer 205 restricts thermocouple wires 125 from bending at the edge of central portion 315 to reduce strain on the seals formed at holes 405 in central portion 315.

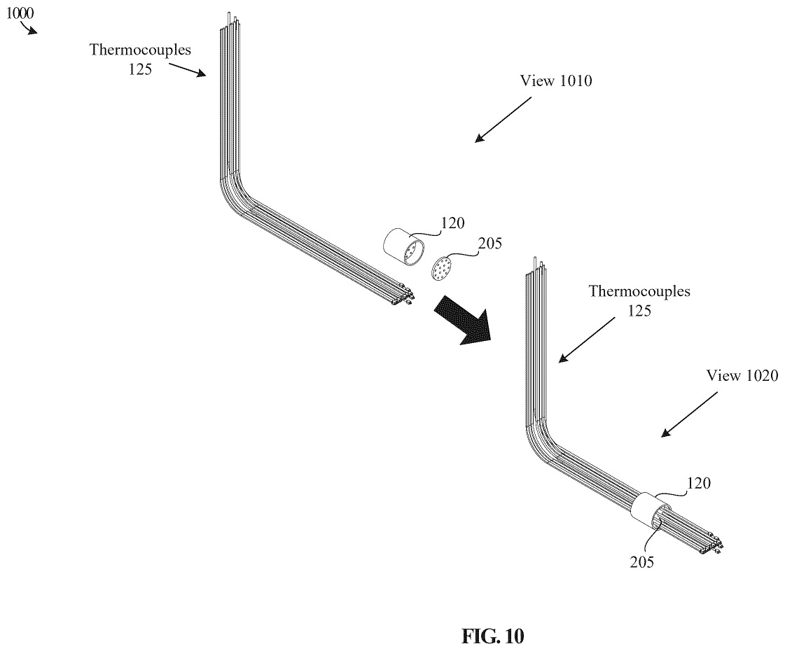

FIG. 10 illustrates a step 1000 of assembling thermocouple harness 100, according to various embodiments of the present disclosure. As shown in view 1010, step 1000 begins with thermocouples 125, cylindrical sealant 120, and optionally, strain relief washer 205. Cylindrical sealant 120 may be machined to include the appropriate number of holes 405 to accommodate the number of thermocouples 125 included. Thermocouples 125 are routed through holes 405 of cylindrical sealant 120 and, optionally, through holes 505 of strain relief washer 205. In some embodiments, thermocouple harness 100 does not include strain relief washer 205. Seals 410 are applied to fill the clearance within holes 405 (i.e., the space within holes 405 not filled by thermocouples 125). For example, seals 410 may be applied by sintering powdered glass material to form a glass seal. View 1020 illustrates the configuration of parts at the end of step 1000.

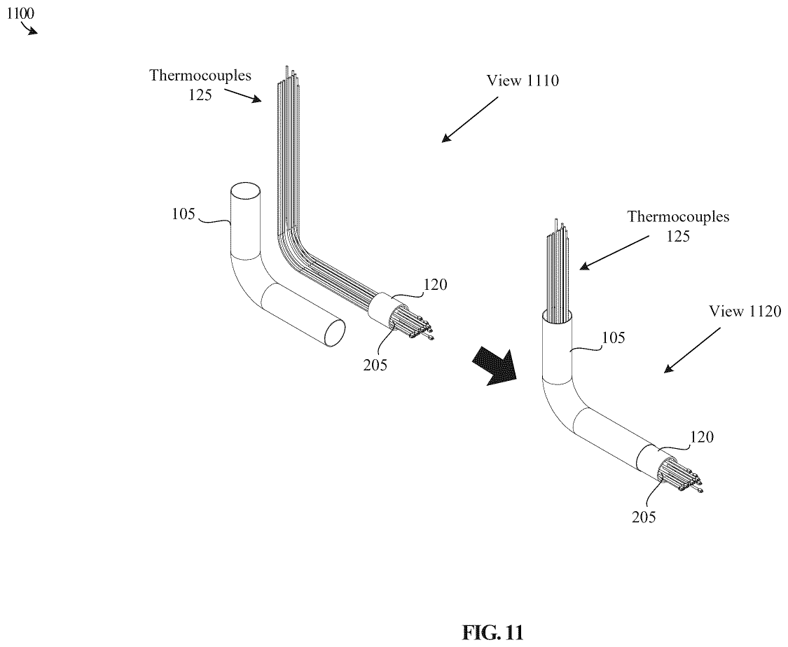

FIG. 11 illustrates step 1100 of assembling thermocouple harness 100, according to various embodiments of the present disclosure. As shown in view 1110, step 1100 begins with the assembled components completed in step 1000 and main body 105. Thermocouples 125 are routed through main body 105. Main body 105 slides over a small distance (e.g., 1 mm to 3 mm) of cylindrical sealant 120, and they are mechanically joined (e.g., by welding, brazing, soldering, or the like). In some embodiments, main body 105 does not slide over cylindrical sealant 120. Instead, the edges of main body 105 and cylindrical sealant 120 may be aligned and joined. To join main body 105 and cylindrical sealant 120, the entire joint is sealed by welding, brazing, soldering, or the like to ensure the junction is airtight. View 1120 illustrates the configuration of parts at the end of step 1100.

FIG. 12 illustrates step 1200 of assembling thermocouple harness 100, according to various embodiments of the present disclosure. As shown in view 1210, step 1200 begins with the assembled components completed in step 1100 and top tube 110. Thermocouples 125 are routed through top tube 110. Top tube 110 slides over a small distance (e.g., 1 mm to 3 mm) of main body 105, and they are mechanically joined (e.g., by welding, brazing, soldering, or the like). To join main body 105 and top tube 110, the entire joint is sealed by welding, brazing, soldering, or the like to ensure the junction is airtight. View 1220 illustrates the configuration of parts at the end of step 1200.

FIG. 13 illustrates step 1300 of assembling thermocouple harness 100 in base 600, according to various embodiments of the present disclosure. Step 1300 begins with the assembled components completed in step 1200 and hotbox base 600. The assembled components are positioned in space 620 such that top tube 110 is placed in a hole formed in ATO skirt 610, and cylindrical sealant 120 extends through a hole formed in the wall of free flow pan 605. Main body 105 may be sufficiently flexible to accommodate at least some movement to position the components as described. Once positioned, top tube 110 is joined to top plate 612 of ATO skirt 610. Weld joint 1305 is depicted to illustrate the coupling. Weld joint 1305 extends around the entire circumference of top tube 110. Similarly, top tube 110 is joined to bottom plate 614 of ATO skirt 610 at weld joint 1306. Weld joint 1306 extends around the entire circumference of top tube 110. Further, cylindrical sealant 120 is joined to the wall of free flow pan 605. Weld joint 1310 is depicted to illustrate the coupling. Weld joint 1310 extends around the entire circumference of cylindrical sealant 120. Once top tube 110 is joined to ATO skirt 610, putty 115 is disposed within top tube 110. The process depicted in FIGS. 10-13 may be repeated for each thermocouple harness 100 in hotbox base 600. Hotbox base 600 with thermocouple harnesses 100 may then be further used to complete assembly of the hotbox (e.g., hotbox 1502).

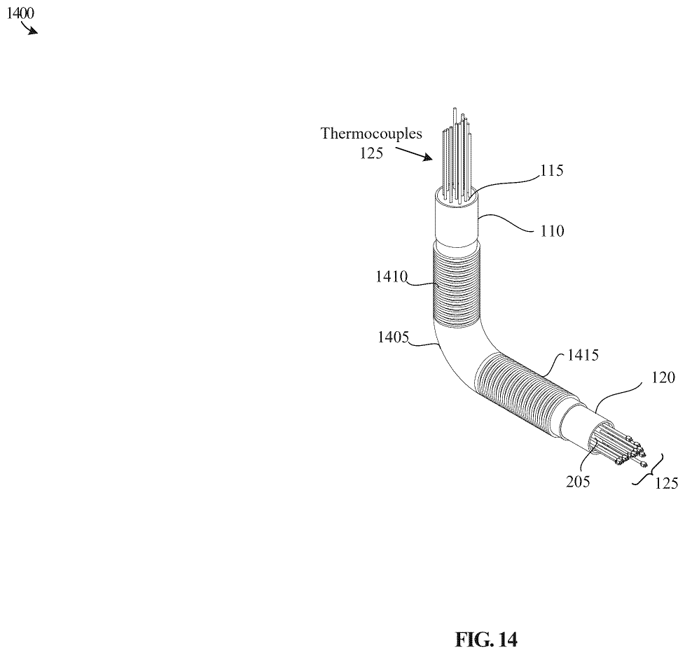

FIG. 14 illustrates an alternative embodiment of a thermocouple harness 1400 having bellows 1410, 1415 in main body 1405, according to various embodiments of the present disclosure. The difference between main body 105 and main body 1405 is that main body 1405 includes bellows 1410 and 1415. Bellows 1410 and 1415 may provide flexibility in main body 1405 for movement and positioning thermocouple harness 100 in base 600 during assembly. Further, bellows 1410 and 1415 may provide strain relief on the joints coupling thermocouple harness 1400 to ATO skirt 610 and to free flow pan 605. For example, physical forces exerted on ATO skirt 610, free flow pan 605, or thermocouple harness 1400 may strain the joints at which they are coupled. Additionally, thermal changes may strain the joints due to differing behaviors (e.g., due to different coefficients of thermal expansion) of the ATO skirt 610, free flow pan 605, and/or thermocouple harness 1400 in response to the thermal changes. Bellows 1410 and 1415 may reduce the strain by allowing main body 1405 to move to compensate for the forces causing the strain. Additionally, bellows may make the final fuel cell system more durable if installed in a setting where the system is subjected to jostling (e.g., if the fuel cell system is installed on a rail or marine transportation system).

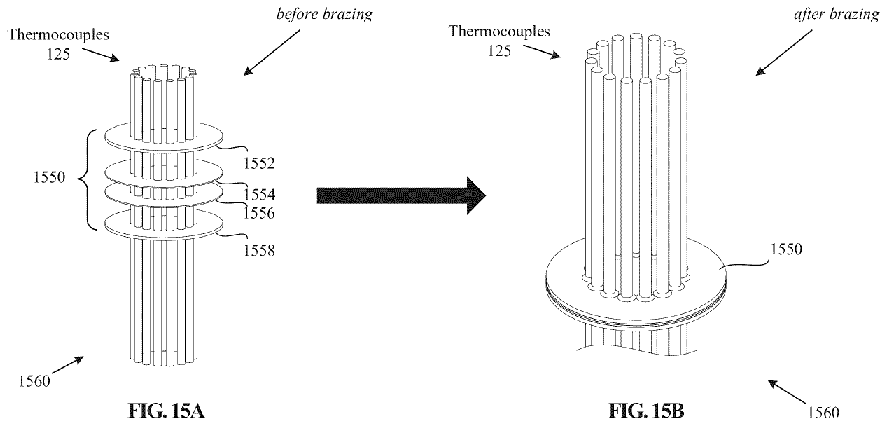

FIG. 15A illustrates another thermocouple harness 1560, depicted before brazing. Thermocouple harness 1560 includes feedthrough washer 1550, which includes first metal disk 1552, second metal disk 1558, and a braze alloy layer between the metal disks 1552, 1558. The braze alloy layer depicted in FIG. 15A includes two braze foils 1554, 1556.

Thermocouple wires 125 are generally representative of the thermocouple wires discussed throughout this disclosure. There may be any number of thermocouple wires in thermocouple harness 1560 such as between eight and thirty.

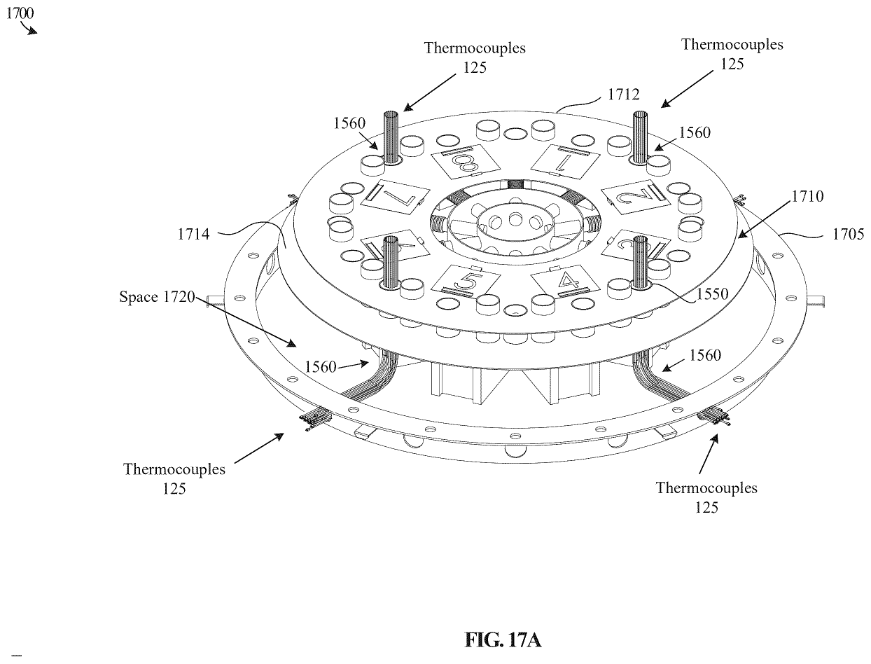

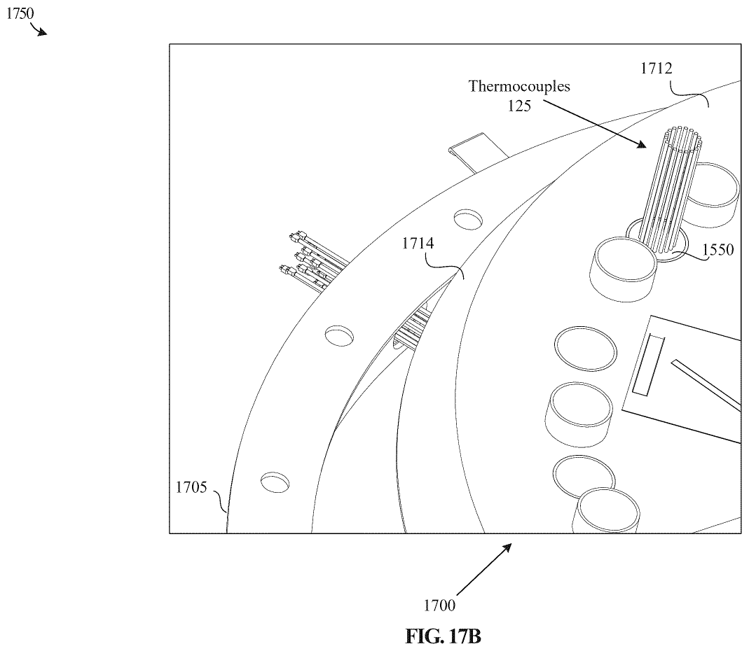

First metal disk 1552 and second metal disk 1558 may each be made from a metallic material suitable for coupling with a brazing process such as a nickel-based alloy, or any other pure or alloy materials including aluminum, copper, brass, bronze, stainless steel, titanium, or the like. Each metal disk 1552, 1558 includes a number of holes extending between the flat surfaces of the respective metal disk 1552, 1558. The holes may be spaced about the flat surfaces and include one hole for each thermocouple wire 125. The diameter of each metal disk 1552, 1558 may be any diameter suitable for routing thermocouple wires 125. Accordingly, the diameter may depend on the number of thermocouples 125 needed. For example, the diameter of each metal disk 1552, 1558 may be 15 millimeters (mm) to 200 mm. In some embodiments, the diameter of first metal disk 1552 may be different than the diameter of second metal disk 1558. For example, the diameter of first metal disk 1552 may be larger than the diameter of second metal disk 1558 such that first metal disk 1552 sits atop top plate 1712 of ATO skirt 1710 of hotbox base 1700 (see FIGS. 17A and 17B) and second metal disk 1558 sits within ATO skirt 1710. Each metal disk may have a thickness (i.e., the distance between the two flat surfaces of the metal disk). The thickness may be any suitable thickness such as between 1.0 mm-10.0 mm. The diameter of each hole is sized to within a tolerance of the diameter of a thermocouple wire 125 to allow the thermocouple wire 125 to pass through the hole. To ensure proper sealing, the tolerance may be small, such as nominal +0.100 mm/−0.000 maximum. However, the tolerance may be larger in some embodiments including any tolerance between nominal +0.050 mm/—0.000 maximum and +0.500 mm/−0.000 maximum. The holes may be spaced circumferentially (i.e., in a ring) or in any other suitable configuration. The distance between any two neighboring holes may be any distance sufficient to ensure structural support such as a distance equal to or larger than the diameter of the holes. The holes in first metal disk 1552 align with the holes in metal disk 1558 such that thermocouple wires 125 may be fed through both metal disks 1552, 1558 with no space between metal disks 1552, 1558.

The braze alloy layer includes material used for brazing metal disks 1552, 1558 together and also wetting the metal sheath of thermocouple wires 125 to seal the space between thermocouple wires 125 and the edges of the holes of metal disks 1552, 1558. As depicted in FIG. 15A, the braze alloy layer includes braze foil 1554 and braze foil 1556. While two braze foils 1554, 1556 are depicted, the braze alloy layer may include any number of foils or any suitable brazing filler without departing from the scope and spirit of this disclosure. Braze foils 1554, 1556 may be preformed, in some embodiments, and may be shaped to fit (e.g., have the same diameter as) metal disks 1552, 1558 and include holes aligned with the holes in metal disks 1552, 1558. Braze foils 1554, 1556 may be any suitable brazing material such as metallic alloys including silver, copper, nickel, and titanium. In some embodiments, the material for braze foils 1554, 1556 may be selected based on the type of metal used for metal disks 1552, 1558. In some embodiments, braze foils 1554, 1556 may be amorphous brazing foils. Braze foils 1554, 1556 may be any suitable thickness such as between 20 micrometers to 2 millimeters.

FIG. 15B illustrates thermocouple harness 1560, depicted after brazing. As shown, metal disks 1552, 1558 and braze foils 1554, 1556 are pressed together to remove space between each such that the braze alloy layer is between first metal disk 1552 and second metal disk 1558 to form feedthrough washer 1550. While thermocouple wires 125 are fed through feedthrough washer 1550, induction brazing is used to melt braze foils 1554, 1556, which joins metal disks 1552, 1558 together and seals the space between each thermocouple wire 125 and the edge of its respective hole in metal disks 1552, 1558.

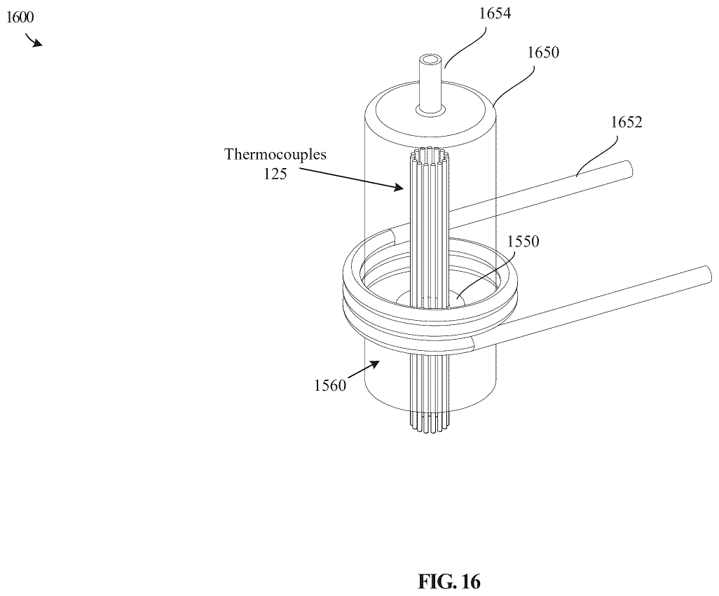

FIG. 16 illustrates an induction brazing system 1600 that may be used to braze metal disks 1552, 1558 together, bind thermocouples 125 in their respective holes, and seal any space left in the respective holes. While any coupling technique may be used, brazing, and particularly induction brazing has advantages. Induction brazing allows all thermocouple wires 125 and metal disks 1552, 1558 to be coupled at one time with a single induction brazing process using uniform local heating that is sufficiently high to complete the brazing process while not causing thermal damage or distortion to the thermocouple wires 125. Other brazing techniques such as vacuum furnace brazing, torch brazing, inert atmosphere control brazing, and the like may be alternatively used to couple metal disks 1552, 1558 and seal unfilled space in the holes of metal disks 1552, 1558 and bind to thermocouple wires 125. These other brazing techniques may be used even if they may have disadvantages. For example, vacuum furnace brazing exposes the entire thermocouple wire 125 to heat, which may create thermal damage or distortion if not closely controlled. As another example, torch brazing does not allow all thermocouple wires 125 to be brazed at one time, which increases process time. Nonetheless, these other brazing techniques may be used notwithstanding the disadvantages without departing from the spirit and scope of the present disclosure. For other brazing methods, the type of flux or brazing alloy layer used may be selected to reduce oxidation and the heating fuel or method may be selected to reduce thermal impact while still performing the mechanical joining desired to form the relevant scaling. For example, using torch brazing as an example, torch brazing with hydrogen, acetylene, or propane gas at low temperatures may be performed. More particularly with respect to torch brazing, to minimize oxidation, flux may be used and hydrogen gas may be preferred.

Induction brazing system 1600 includes brazing jar 1650 and induction coil 1652. Thermocouple harness 1560, including feedthrough washer 1550 and thermocouple wires 125, is placed within brazing jar 1650. Brazing jar 1650 may be a glass bell jar connected at gas inlet 1654 to a supply of gas such as argon, hydrogen, or argon/hydrogen mix gas. The gas creates an inert or reduced atmosphere to mitigate oxidation of feedthrough washer 1550. Induction coil 1652 is wrapped around brazing jar 1650. Induction coil 1652 may be any conductive coil connected to an alternating current (AC) power supply.

To perform the induction brazing, thermocouple harness 1560 is placed within brazing jar 1650. The gas supply is opened to flow the gas through gas inlet 1654 into brazing jar 1650 to purge air from the space surrounding feedthrough washer 1550. The power supply is turned on for a time period to induce inductive heating due to the change in the magnetic field within brazing jar 1650 caused by the alternating current. The time period is selected to create sufficient heat to melt braze foils 1554, 1556 without causing thermal damage or distortion to thermocouple wires 125.

In some embodiments, brazing jar 1650 may be large enough to allow for multiple thermocouple harnesses 1560 to be brazed at one time, multiple induction coils 1652 may be used, indexing cassette trays may be used, or a continuous belt conveyor may be implemented to increase the volume of thermocouple harnesses 1560 brazed at once or within a time period.

FIG. 17A illustrates hotbox base 1700 with multiple thermocouple harnesses 1560 incorporated and assembled, according to various embodiments of the present disclosure. Hotbox base 1700 is substantially the same as hotbox base 600 with the difference of using thermocouple harnesses 100 in hotbox base 600 and thermocouple harnesses 1560 in hotbox base 1700. Hotbox base 1700 includes four thermocouple harnesses 1560, however a larger or smaller number of thermocouple harnesses 1560 may be included in hotbox base 1700. Hotbox base 1700 includes free flow pan 1705, anode tail gas oxidizer (ATO) skirt 1710 (comprising top plate 1712 and bottom plate 1714), and space 1720.

One or more fuel cell columns may be placed above top plate 1712 of ATO skirt 1710. FIG. 17A illustrates locations for eight fuel cell columns, though a larger or smaller number of fuel cell columns may be used. Details of the hotbox are further described in FIGS. 19-22. Accordingly, the portions of thermocouples 125 that extend out of feedthrough washer 1550 of each thermocouple harness 100 at ATO skirt 1710 extend into high temperature regions of the hotbox. Feedthrough washer 1550 of each thermocouple harness 1560 is mechanically joined (e.g., by welding, brazing, soldering, or the like) to ATO skirt 1710. The joint at which feedthrough washer 1550 is coupled to ATO skirt 1710 is sealed, for example by welding, around the entire circumference of feedthrough washer 1550. In some examples, the top of feedthrough washer 1550 may be flush with top plate 1712 and may be joined to top plate 1712, and the bottom of feedthrough washer 1550 may be flush with bottom plate 1714 and joined to top plate 1712. To join feedthrough washer 1550 to top plate 1712 and bottom plate 1714, feedthrough washer 1550 may be welded around the entire circumference such that a gas tight seal is formed to avoid heated air above top plate 1712 from mixing with ATO exhaust flowing between top plate 1712 and bottom plate 1714. In some embodiments, only the top of feedthrough washer 1550 is welded, forming the gas tight seal.

Free flow pan 1705 forms an exterior edge of hotbox base 1700 such that where thermocouples 125 extend out of free flow pan 1705, they extend to the exterior of the hotbox. Free flow pan 1705 is pan shaped, having a flat surface forming the bottom of hotbox base 1700 and having a wall portion that extends substantially perpendicularly from the flat surface the entire distance around the flat surface to create a partially enclosed area as shown in FIG. 17A. Thermocouple wires 125 may be routed through the wall of free flow pan 1705. Space 1720 represents the space between bottom plate 1714 of ATO skirt 1710 and the flat surface of free flow pan 1705. Thermocouple wires 125 are routed through space 1720 as shown in FIG. 17A. In some embodiments, space 1720 may be filled with insulation such that insulation surrounds the portion of thermocouple wires 125 that are routed through space 1720.

FIG. 17B illustrates a perspective view 1750 of hotbox base 1700. As shown in perspective view 1750, feedthrough washer 1550 may sit atop of top plate 1712 of ATO skirt 1710. Feedthrough washer 1550 may be joined to top plate 1712 by welding around the circumference of feedthrough washer 1550 to seal the hole in top plate 1712 though which thermocouple wires 125 of thermocouple harness 1560 extend. Another hole in bottom plate 1714 allow thermocouple wires 125 to extend into space 1720. Thermocouple wires 125 are routed through space 1720 and out a hole in the wall of free flow pan 1705. The seal provided by brazing metal disks 1552, 1558 together with thermocouple wires 125 ensures no gas or heat escapes from the interior of the hotbox through holes in metal disks 1552, 1558. Welding feedthrough washer 1550 to top plate 1712 ensures no heat or gas escapes from the interior of the hotbox through the hole in top plate 1712. No further sealing below top plate 1712 is necessary due to the seals formed in and around feedthrough washer 1550.

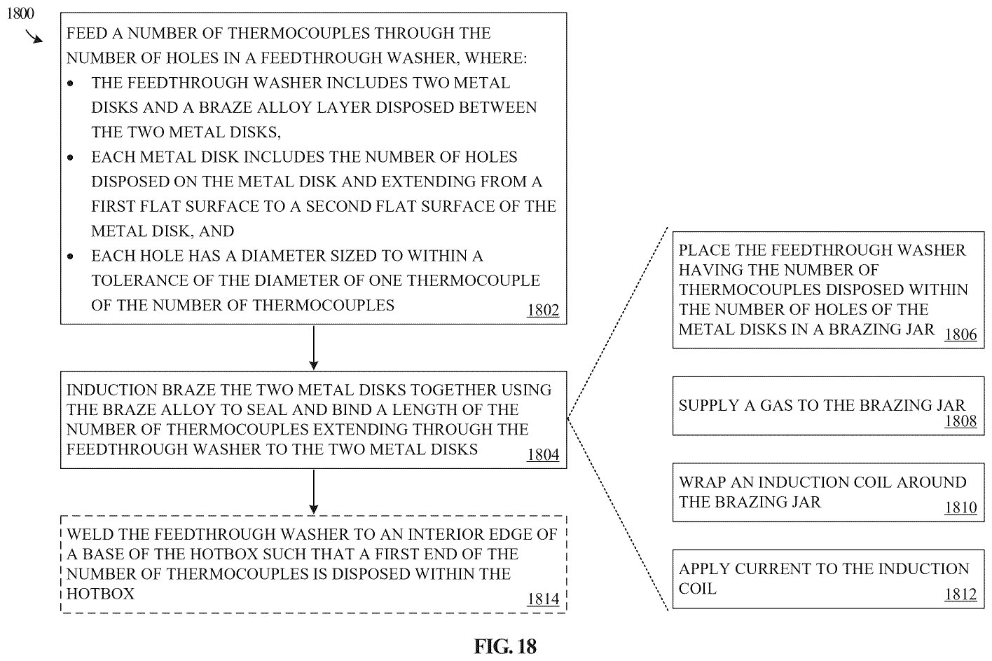

FIG. 18 illustrates a method 1800 of manufacturing a thermocouple harness (e.g., thermocouple harness 1560). Method 1800 may include more steps than those depicted, and steps may be performed in a different order. Method 1800 may be performed using, for example, induction brazing system 1600 described and depicted with respect to FIG. 16.

At step 1802, a number of thermocouples (e.g., thermocouples 125) are fed through the number of holes in a feedthrough washer (e.g., feedthrough washer 1550) where the feedthrough washer includes two metal disks (e.g., metal disks 1552, 1558) and a braze alloy layer (e.g., braze foils 1554, 1556) disposed between the two metal disks. Each metal disk includes the number of holes disposed on the metal disk and extending from a first flat surface to a second flat surface of the metal disk, and each hole has a diameter sized to within a tolerance of the diameter of one thermocouple of the thermocouples. For example, the holes may be placed circumferentially about the metal disk or in any other suitable pattern. The tolerance may be no greater than nominal +0.500 mm/−0.000 maximum in some examples.

At step 1804, the two metal disks (e.g., metal disks 1552, 1558) are induction brazed together using the braze alloy layer to seal and bind a length of the number of thermocouples extending through the feedthrough washer to the two metal disks. The induction brazing can include steps 1806, 1808, 1810, and 1812.

At step 1806, the feedthrough washer (e.g., feedthrough washer 1550) having the number of thermocouples (e.g., thermocouples 125) disposed within the number of holes of the metal disks (e.g., metal disks 1552, 1558) and with the braze alloy layer (e.g., braze foils 1554, 1556) between is placed in a brazing jar (e.g., brazing jar 1650). At step 1808 gas is supplied to the brazing jar. For example, argon, hydrogen, or an argon/hydrogen mix may be supplied through a gas inlet (e.g., gas inlet 1654) to displace air in the brazing jar to create an inert atmosphere surrounding the brazing materials such as the two metal disks and the brazing alloy layer.

At step 1810 an induction coil (e.g., induction coil 1652) is wrapped around the brazing jar. The induction coil is wrapped such that when a current is applied to the induction coil, a changing magnetic field induces induction heating within the brazing jar.

At step 1812, current is applied to the induction coil. The induction heating melts the braze alloy layer, coupling the two metal disks and joining the thermocouples in the holes and sealing any space between the thermocouples and the edges of the holes.

At optional step 1814, the feedthrough washer (e.g., feedthrough washer 1550) is welded to an interior edge of a hotbox base (e.g., hotbox base 1700) such that a first end of the thermocouples is disposed within the hotbox.

FIG. 19 is a schematic representation of a SOFC system 1900 in which the thermocouple harness 100 may be incorporated, according to various embodiments of the present disclosure. Referring to FIG. 19, the system 1900 includes a hotbox 1502 and various components disposed therein or adjacent thereto. The hotbox 1502 is representative of a hotbox that may utilize hotbox base 600 or 1700 as described with respect to FIGS. 6 and 17A. The hotbox 1502 may contain fuel cell stacks 1504, such as a solid oxide fuel cell stacks containing alternating fuel cells and interconnects. One solid oxide fuel cell of the stack contains a ceramic electrolyte, such as yttria stabilized zirconia (YSZ), scandia stabilized zirconia (SSZ), scandia and ceria stabilized zirconia or scandia, yttria and ceria stabilized zirconia, an anode electrode, such as a nickel-YSZ, a nickel-SSZ or nickel-doped ceria cermet, and a cathode electrode, such as lanthanum strontium manganite (LSM). The interconnects may be metal alloy interconnects, such as chromium-iron alloy interconnects. The stacks 1504 may be arranged over each other to create a single column with a plurality of columns contained in a single hotbox, or each stack may comprise one large column with multiple columns contained in a single hotbox.

The hotbox 1502 may also contain an anode recuperator heat exchanger 1510, a cathode recuperator heat exchanger 1520, an anode tail gas oxidizer (ATO) 1532, an anode exhaust cooler heat exchanger 1542, a splitter 1506, and a vortex generator 1536. The system 1900 may also include a catalytic partial oxidation (CPOx) reactor 1530, a mixer 1540, a CPOx blower 1534 (e.g., air blower), a system blower 1538 (e.g., air blower), and an anode recycle blower 1544, which may be disposed outside of the hotbox 1502. However, the present disclosure is not limited to any particular location for each of the components with respect to the hotbox 1502.

The CPOx reactor 1530 receives a fuel inlet stream from fuel inlet 1522, through fuel conduit 1522A. The fuel inlet 1522 may be a fuel tank or a utility natural gas line including a valve to control an amount of fuel provided to the CPOx reactor 1530. The CPOx blower 1534 may provide air to the CPOx reactor 1530 during system start-up. The fuel and/or air may be provided to the mixer 1540 by fuel conduit 1522B. Fuel flows from the mixer 1540 to the anode recuperator 1510 through fuel conduit 1522C. The fuel is heated in the anode recuperator 1510 by a portion of the fuel exhaust supplied by conduit 1508A and the fuel then flows from the anode recuperator 1510 to the stacks 1504 through fuel conduit 1522D.

The system blower 1538 may be configured to provide an air stream (e.g., air inlet stream) to the anode exhaust cooler 1542 through air conduit 1524A. Air flows from the anode exhaust cooler 1542 to the cathode recuperator 1520 through air conduit 1524B. The air is heated by the ATO exhaust in cathode recuperator 1520. The air flows from the cathode recuperator 1520 to the stacks 1504 through air conduit 1524C.

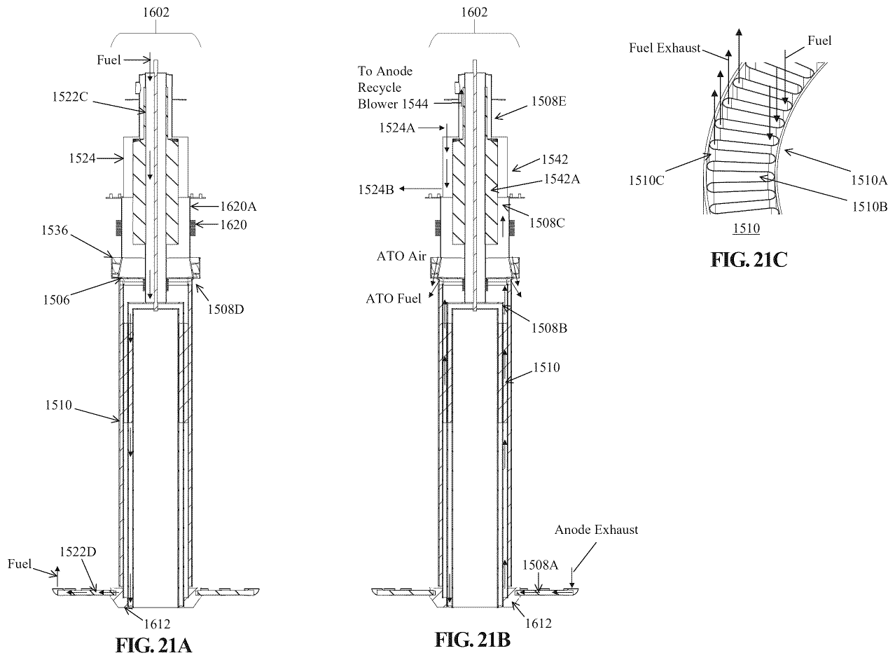

An anode exhaust stream (e.g., the fuel exhaust stream described below with respect to FIGS. 21A-21C) generated in stacks 1504 is provided to the anode recuperator 1510 through anode exhaust conduit 1508A. The anode exhaust may contain unreacted fuel and may also be referred to herein as fuel exhaust. The anode exhaust may be provided from the anode recuperator 1510 to the splitter 1506 by anode exhaust conduit 1508B. A first portion of the anode exhaust may be provided from the splitter 1506 to the anode exhaust cooler 1542 through the anode exhaust conduit 1508C. A second portion of the anode exhaust may be provided from the splitter 1506 to the ATO 1532 through the anode exhaust conduit 1508D. The first portion of the anode exhaust heats the air inlet stream in the anode exhaust cooler 1542 and may then be provided from the anode exhaust cooler 1542 to the mixer 1540 through the anode exhaust conduit 1508E. The anode recycle blower 1544 may be configured to move anode exhaust though anode exhaust conduit 1508E.

Cathode exhaust generated in stacks 1504 flows to the ATO 1532 through cathode exhaust conduit 1518A. The vortex generator 1536 may be disposed in the exhaust conduit 1518A and may be configured to swirl the cathode exhaust. The anode exhaust conduit 1508D may be fluidly connected to the vortex generator 1536 or to the cathode exhaust conduit 1518A or the ATO 1532 downstream of the vortex generator 1536. The swirled cathode exhaust may mix with the second portion of the anode exhaust provided by the splitter 1506 before being provided to the ATO 1532. The mixture may be oxidized in the ATO 1532 to generate an ATO exhaust. The ATO exhaust flows from the ATO 1532 to the cathode recuperator 1520 through the cathode exhaust conduit 1518B. Exhaust flows from the cathode recuperator and out of the hotbox 1502 through cathode exhaust conduit 1518C.

An optional water injector (not shown) may be provided on the anode exhaust conduit 1508C. The water injector may comprise a nozzle or pipe connected to a water source (e.g., water tank or municipal water supply pipe). The injector injects the water into the anode exhaust stream, where the water is vaporized and converted to steam. Alternatively or in addition, a steam generator (not shown in FIG. 19) may be located in the hotbox 1502 to provide steam into the mixer 1540. The steam generator may comprise one or more water pipes located in the path of the cathode exhaust stream, such that the cathode exhaust stream exiting the cathode recuperator 1520 via conduit 1518C vaporizes the water in the one or more water pipes.

The system 1900 may further contain a system controller 1546 configured to control various elements of the system 1900. Controller 1546 may include a central processing unit configured to execute stored instructions. For example, controller 1546 may be configured to control fuel and/or air flow through the system 1900, according to fuel composition data.

FIG. 20A is a sectional view showing components of the hotbox 1502 of the system 1900 of FIG. 19, and FIG. 20B shows an enlarged portion of FIG. 20A. FIG. 20C is a three-dimensional cut-away view of a central column 1602 of the hotbox 1502 in system 1900, according to various embodiments of the present disclosure, and FIG. 20D is a perspective view of an anode hub structure 1606 disposed in a hotbox base 1604. Hotbox base 1604 may be hotbox base 600 or 1700 as described with respect to FIGS. 6 and 17A such that thermocouple harnesses 100 or thermocouple harness 1560 may be positioned within hotbox base 1604 as described throughout this disclosure.

Referring to FIGS. 20A-20D, the fuel cell stacks 1504 may be disposed around the central column 1602 in hotbox 1502. For example, the stacks 1504 may be disposed in a ring configuration around the central column 1602 and may be positioned over the hotbox base 1604. The interior 1614 of hotbox 1502 is enclosed by a cover 1616 and hotbox base 1604. The central column 1602 may include the anode recuperator 1510, the ATO 1532, and the anode exhaust cooler 1542. In particular, the anode recuperator 1510 is disposed radially inward of the ATO 1532, and the anode exhaust cooler 1542 is mounted over the anode recuperator 1510 and the ATO 1532. In one embodiment, an oxidation catalyst 1512 and/or a hydrogenation catalyst 1514 may be located in the anode recuperator 1510 (see FIGS. 19 and 20C). A reforming catalyst 1516 may also be located at the bottom of the anode recuperator 1510 as a steam methane reformation (SMR) insert. The ATO 1532 may include an oxidation catalyst.

The anode hub structure 1606 may be positioned under the anode recuperator 1510 and ATO 1532 and over the hotbox base 1604. The anode hub structure 1606 is covered by an ATO skirt 1636. ATO skirt 1636 may be ATO skirt 610 or ATO skirt 1710 described with respect to FIGS. 6 and 17A. The vortex generator 1536 and fuel exhaust splitter 1506 are located over the anode recuperator 1510 and ATO 1532 and below the anode exhaust cooler 1542. An ATO glow plug 1632, which initiates the oxidation of the stack fuel exhaust in the ATO during startup, may be located near the bottom of the ATO 1532.

The anode hub structure 1606 is used to distribute fuel evenly from the central column to fuel cell stacks 1504 disposed around the central column 1602. The anode flow hub structure 1606 includes a grooved cast base 1612 and a “spider” hub of fuel inlet conduits 1522D and outlet conduits 1508A. Each pair of conduits 1522D, 1508A connects to a fuel cell stack 1504. Anode side cylinders (e.g., anode recuperator 1510 inner and outer cylinders and ATO 1532 outer cylinder) are then welded or brazed into the grooves in the grooved cast base 1612, creating a uniform volume cross section for flow distribution as discussed below.

A lift base 1634 is located under the hotbox base 1604, as illustrated in FIG. 20C. In an embodiment, lift base 1634 includes two hollow arms with which the forks of a forklift can be inserted to lift and move the system, such as to remove the system from a cabinet (not shown) for repair or servicing.

As shown by the arrows in FIGS. 20A and 20B, air enters the top of the hotbox 1502 and flows through the anode exhaust cooler 1542 where it is heated by anode exhaust and then flows into the cathode recuperator 1520 where it is heated by ATO exhaust (not shown) from the ATO 1532. The heated air then flows inside the cathode recuperator 1520 through a first vent or opening 1608. The air then flows through the stacks 1504 and reacts with fuel (i.e., fuel inlet stream) provided from the anode hub structure 1606. Air exhaust flows from the stacks 1504, through a second vent or opening 1610. The air exhaust then passes through vanes of vortex generator 1536 and is swirled before entering the ATO 1532.

The splitter 1506 may direct the second portion of the fuel exhaust exiting the top of the anode recuperator 1510 through openings (e.g., slits) in the splitter into the swirled air exhaust (e.g., in the vortex generator 1536 or downstream of the vortex generator in the cathode exhaust conduit 1518A or in the ATO 1532). At such location, the fuel and air exhaust may be mixed before entering the ATO 1532.

FIGS. 21A and 21B are side cross-sectional views showing flow distribution through the central column 1602, and 17C is a partial perspective view taken through the anode recuperator 1510. Referring to FIGS. 20A, 20B, 21A, and 21C, the anode recuperator 1510 includes an inner cylinder 1510A, a corrugated plate 1510B, and an outer cylinder 1510C. Fuel from fuel conduit 1522C enters the top of the central column 1602. The fuel then bypasses the anode exhaust cooler 1542 by flowing through its hollow core and then flows through the anode recuperator 1510, between the outer cylinder 1510C and the and the corrugated plate 1510B. The fuel then flows through hub base 1612 and conduits 1522D of the anode hub structure 1606 shown in FIG. 21B, to the stacks 1504.

Referring to FIGS. 20A, 20B, 20C, 21A, and 21B, the fuel exhaust flows from the stacks 1504 through conduits 1508A into the hub base 1612, and from the hub base 1612 through the anode recuperator 1510, between inner cylinder 1510A and the corrugated plate 1510B, and through conduit 1508B into the splitter 1506. A first portion of the fuel exhaust may flow from the splitter 1506 to the anode exhaust cooler 1542 through conduit 1508C, while a second portion may flow from the splitter 1506 to the ATO 1532 through conduit 1508D, as shown in FIG. 19. The relative amounts of anode exhaust provided to the ATO 1532 and the anode exhaust cooler 1542 is controlled by the anode recycle blower 1544. The higher the blower 1544 speed, the larger portion of the anode exhaust is provided into conduit 1508C and a smaller portion of the anode exhaust is provided to the ATO 1532 via conduit 1508D, and vice-versa. Anode exhaust cooler inner core insulation 1542A may be located between the fuel conduit 1522C and bellows 1620/supporting cylinder 1620A located between the anode exhaust cooler 1542 and the vortex generator 1536, as shown in FIG. 21A. This insulation minimizes heat transfer and loss from the first portion of the anode exhaust stream in conduit 1508C on the way to the anode exhaust cooler 1542. Insulation 1542A may also be located between conduit 1522C and the anode exhaust cooler 1542 to avoid heat transfer between the fuel inlet stream in conduit 1522C and the streams in the anode exhaust cooler 1542. In other embodiments, insulation 1542A may be omitted from inside the cylindrical anode exhaust cooler 1542.

FIG. 21B also shows air flowing from the air conduit 1524A to the anode exhaust cooler 1542 (where it is heated by the first portion of the anode exhaust) and then from the anode exhaust cooler 1542 through conduit 1524B to the cathode recuperator 1520. The first portion of the anode exhaust is cooled in the anode exhaust cooler 1542 by the air flowing through the anode exhaust cooler 1542. The cooled first portion of the anode exhaust is then provided from the anode exhaust cooler 1542 to the anode recycle blower 1544 shown in FIG. 19.

The anode exhaust provided to the ATO 1532 is not cooled in the anode exhaust cooler 1542. This allows higher temperature anode exhaust to be provided into the ATO 1532 than if the anode exhaust were provided after flowing through the anode exhaust cooler 1542. For example, the anode exhaust provided into the ATO 1532 from the splitter 1506 may have a temperature of above 350° C., such as from about 350 to about 500° C., for example, from about 375 to about 425° C., or from about 390 to about 410° C. Furthermore, since a smaller amount of anode exhaust is provided into the anode exhaust cooler 1542 (e.g., not 100% of the anode exhaust is provided into the anode exhaust cooler due to the splitting of the anode exhaust in splitter 1506), the heat exchange area of the anode exhaust cooler 1542 may be reduced. The anode exhaust provided to the ATO 1532 may be oxidized by the stack cathode exhaust (i.e., air) and provided to the cathode recuperator 1520 through the cathode exhaust conduit 1518B.

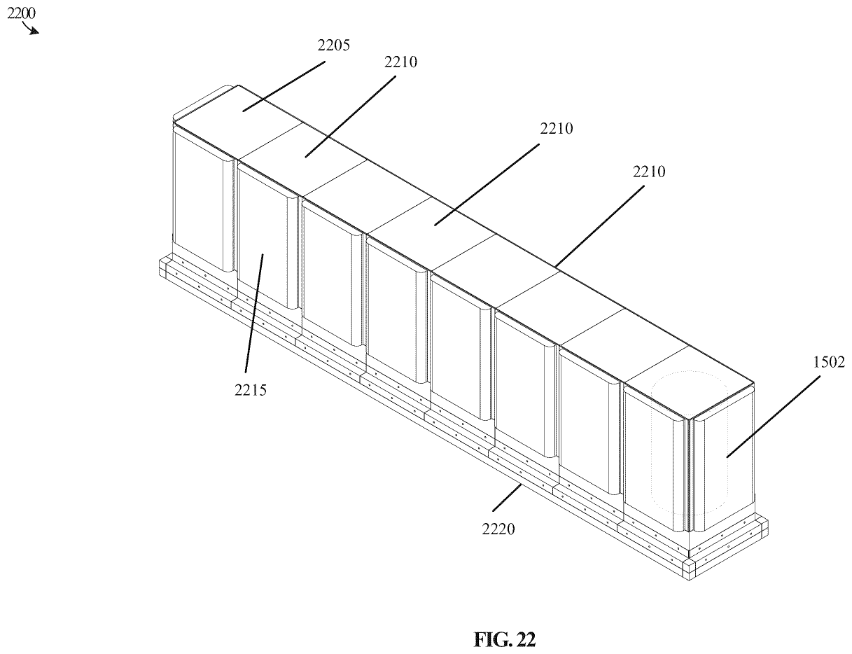

FIG. 22 is a perspective view of a modular SOFC system 2200, according to various embodiments of the present disclosure. Referring to FIG. 22, the fuel cell system 2200 may contain modules and components described in U.S. Pat. Nos. 9,190,693 and 9,755,263, which are incorporated herein by reference in their entireties. The modular design of the fuel cell system 2200 provides flexible system installation and operation. Modules allow scaling of installed generating capacity, reliable generation of power, flexibility of fuel processing, and flexibility of power output voltages and frequencies with a single design set. The modular design results in an “always on” unit with very high availability and reliability. This design also provides an easy means of scale up to meet specific requirements of customer installations. The modular design also allows the use of available fuels and required voltages and frequencies which may vary by customer and/or by geographic region.

The modular fuel cell system 2200 includes one or more fuel cell power modules 2210 and one or more power conditioning (i.e., electrical output) modules 2205. In embodiments, the power conditioning modules 2205 are configured to deliver direct current (DC). In alternative embodiments, the power conditioning modules 2205 are configured to deliver alternating current (AC). In these embodiments, the power conditioning modules 2205 include a mechanism to convert DC to AC, such as an inverter. For example, the fuel cell system 2200 may include any desired number of modules, such as 2-30 power modules, for example 3-12 power modules, such as 6-12 modules.

The fuel cell system 2200 of FIG. 22 includes a row of seven power modules 2210 and one power conditioning module 2205 disposed on a pad 2220. While one row of power modules 2210 is shown, the fuel cell system 2200 may comprise more than one row of modules 2210. For example, the fuel cell system 2200 may comprise two rows of power modules 2210 arranged back-to-back/end-to-end.

E Each power module 2210 is configured to house one or more hotboxes 1502. Each hotbox 1502 contains one or more stacks or columns of fuel cells (not shown for clarity), such as one or more stacks or columns of SOFCs having a ceramic oxide electrolyte separated by conductive interconnect plates.

The fuel cell stacks may comprise externally and/or internally manifolded stacks. For example, the stacks may be internally manifolded for fuel and air with fuel and air risers extending through openings in the fuel cell layers and/or in the interconnect plates between the fuel cells.

Alternatively, the fuel cell stacks may be internally manifolded for fuel and externally manifolded for air, where only the fuel inlet and exhaust risers extend through openings in the fuel cell layers and/or in the interconnect plates between the fuel cells, as described in U.S. Pat. No. 7,713,649, which is incorporated herein by reference in its entirety. The fuel cells may have a cross flow (where air and fuel flow roughly perpendicular to each other on opposite sides of the electrolyte in each fuel cell), counter flow parallel (where air and fuel flow roughly parallel to each other but in opposite directions on opposite sides of the electrolyte in each fuel cell) or co-flow parallel (where air and fuel flow roughly parallel to each other in the same direction on opposite sides of the electrolyte in each fuel cell) configuration.

The power conditioning module 2205 includes components for converting the fuel cell stack generated DC power to AC power (e.g., DC/DC and DC/AC converters described in U.S. Pat. No. 7,705,490, incorporated herein by reference in its entirety), electrical connectors for AC power output to the grid, circuits for managing electrical transients, and a system controller (e.g., a computer or dedicated control logic device or circuit). The power conditioning module 2205 may be designed to convert DC power from the fuel cell modules to different AC voltages and frequencies. Designs for 208V, 60 Hz; 480V, 60 Hz; 415V, 50 Hz and other common voltages and frequencies may be provided.

The linear array of power modules 2210 is readily scaled. For example, more or fewer power modules 2210 may be provided depending on the power needs of the building or other facility serviced by the fuel cell system 2200. The power modules 2210 and input/output modules may also be provided in other ratios. For example, in other exemplary embodiments, more or fewer power modules 2210 may be provided.

The modular fuel cell system 2200 may be configured in a way to case servicing of the components of the fuel cell system 2200. For example, the fuel cell system 2200 may include access doors 2215. All of the routinely or high serviced components (such as the consumable components) may be placed in a single module to reduce the amount of time required for the service person.

For example, when one power module 2210 is taken offline (i.e., no power is generated by the stacks in the hotbox 1502 in the offline module 2210), the remaining power modules 2210 and the power conditioning module 2205 are not taken offline. Furthermore, the fuel cell system 2200 may contain more than one of each type of module 2210, 2205. When at least one module of a particular type is taken offline, the remaining modules of the same type are not taken offline.

Thus, in a system comprising a plurality of modules, each of the modules 2210 or 2205 may be electrically disconnected, removed from the fuel cell system 2200 and/or serviced or repaired without stopping an operation of the other modules in the system, allowing the fuel cell system to continue to generate electricity. The entire fuel cell system 2200 does not have to be shut down if one stack of fuel cells in one hotbox 1502 malfunctions or is taken offline for servicing.

While an SOFC system has been described in detail herein, the thermocouple harnesses of the present disclosure are equally applicable for use in solid oxide electrolyzer cell (SOEC) systems. In a SOFC system, an oxidizing flow is passed through the air side (which is the cathode side) of the fuel cell while a fuel flow is passed through the fuel side (which is the anode side) of the fuel cell. The oxidizing flow is typically air, while the fuel flow can be a hydrogen (H₂) or a hydrocarbon fuel, such as methane, natural gas, ethanol, or methanol. The fuel cell enables the transport of negatively charged oxygen ions from the cathode flow stream to the anode flow stream, where the ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between anode and cathode, resulting in an electrical current flow through the circuit. In an electrolyzer system, such as a SOEC system, water (e.g., steam) is separated into hydrogen and oxygen by applying a voltage across the electrolyzer cells. The steam is provided to the fuel side (e.g., the cathode side) of the SOEC and air may be provided to the air side (e.g., anode side) of the SOEC. A voltage is applied between the air and fuel electrodes to cause negatively charged oxygen ions to be transported from the fuel side of the electrolyte to the air side of the electrolyte, where the oxygen ions are provided into the air stream to generate an oxygen enriched air stream. The separated hydrogen is collected from the fuel side of the SOEC. As with SOFC systems, SOEC systems utilize thermocouple devices to measure the temperature and operation of SOEC stacks located inside of a hotbox. Accordingly, the thermocouple harnesses of the present disclosure can be utilized to pass thermocouples into and out of a hotbox containing SOEC columns and stacks.

While SOFC and SOEC systems utilizing the thermocouple harnesses of the present disclosure are described herein, the thermocouple harnesses of the present disclosure can be utilized with other fuel cell and electrolyzer types, such as proton exchange membrane (PEM) fuel cells, molten carbonate fuel cells, phosphoric acid fuel cells, alkaline fuel cells, microbial fuel cells, zinc-air fuel cells, or enzymatic biofuel cells.

The aforementioned discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

What is claimed is:

1. A thermocouple harness for a hotbox of a solid oxide electrochemical system, the thermocouple harness comprising:
a number of thermocouples; and
a feedthrough washer including two metal disks, wherein:
each metal disk comprises the number of holes disposed on the metal disk and extending from a first flat surface of the metal disk to a second flat surface of the metal disk,
each hole comprises a diameter sized to within a tolerance of a diameter of one of the thermocouples,
a thermocouple of the number of thermocouples is disposed within each of the number of holes,
the two metal disks are coupled together and to the number of thermocouples with a braze alloy disposed between the two metal disks, and
the feedthrough washer is configured to be mechanically coupled to an interior edge of a base of the hotbox such that a first end of the thermocouples is disposed within the hotbox.

2. The thermocouple harness of claim 1, wherein the braze alloy layer comprises two or more layers of high-temperature braze foil.

3. The thermocouple harness of claim 1, wherein the solid oxide electrochemical system comprises one of a solid oxide fuel cell system configured to generate electricity and a solid oxide electrolyzer cell system configured to generate a hydrogen product from electrolysis of steam.

4. The thermocouple harness of claim 1, wherein the two metal disks are coupled together and to the number of thermocouples using induction brazing.

5. A method for sealing a thermocouple harness for a hotbox of a solid oxide electrochemical system, the method comprising:
feeding a number of thermocouples through the number of holes in a feedthrough washer,
wherein the feedthrough washer comprises two metal disks and a braze alloy layer disposed between the two metal disks, wherein:
each metal disk comprises the number of holes disposed on the metal disk and extending from a first flat surface of the metal disk to a second flat surface of the metal disk, and
each hole comprises a diameter sized to within a tolerance of a diameter of one thermocouple of the number of thermocouples; and
brazing, with induction brazing, the two metal disks together using the braze alloy layer to seal and bind a length of the number of thermocouples extending through the feedthrough washer to the two metal disks.

6. The method of claim 5, further comprising:
welding the feedthrough washer to an interior edge of a base of the hotbox such that a first end of the number of thermocouples is disposed within the hotbox.

7. The method of claim 5, wherein the induction brazing comprises:
placing the feedthrough washer having the number of thermocouples disposed within the number of holes of the metal disks in a brazing jar;
supplying a gas to the brazing jar;
wrapping an induction coil around the brazing jar; and
applying current to the induction coil.

8. A thermocouple harness for a hotbox of a solid oxide electrochemical system, the thermocouple harness comprising:
a main body comprising a hollow cylinder having a first end and a second end, wherein:
the main body is configured to encircle a first portion of a length of a plurality of thermocouples;
a top tube comprising a second hollow cylinder having a first end and a second end,
wherein:
the second end of the top tube is configured to be mechanically coupled with the first end of the main body, and
the first end of the top tube is configured to be mechanically coupled to an interior edge of a base of the hotbox such that a first end of the thermocouples is disposed within the hotbox;
putty disposed within the top tube, wherein:
the putty is configured to fill the top tube and surround a second portion of the length of the plurality of thermocouples such that the putty creates a heat reducing seal at the base of the hotbox at the location of the top tube;
a cylindrical sealant comprising a back groove disposed on a first end of the cylindrical sealant, a front groove disposed on a second end of the cylindrical sealant, and a central portion between the front groove and the back groove, wherein:
the back groove is configured to be mechanically coupled to the second end of the main body,
the central portion comprises a plurality of holes extending through the central portion from the back groove to the front groove,
each hole of the plurality of holes is configured to receive one of the plurality of thermocouples such that a third portion of the length of the respective thermocouple extends through the respective hole, and
the second end of the cylindrical sealant is configured to be mechanically coupled to an exterior edge of the base of the hotbox such that a second end of the thermocouples is disposed in an exterior of the hotbox; and
a plurality of seals, wherein:
each of the plurality of seals is disposed about the respective thermocouple extending through each of the holes of the central portion of the cylindrical sealant such that the plurality of seals creates a seal between the interior of the hotbox and the exterior of the hotbox.

9. The thermocouple harness of claim 8, wherein the plurality of seals comprise a plurality of glass seals.

10. The thermocouple harness of claim 8, wherein the main body comprises a bellow.

11. The thermocouple harness of claim 8, further comprising:
a strain relief washer comprising a disk and a second plurality of holes, wherein:
the strain relief washer is disposed within the front groove of the cylindrical sealant,
the second plurality of holes align with the plurality of holes of the cylindrical sealant, and
each thermocouple extending through the plurality of holes of the cylindrical sealant extends through a corresponding hole of the second plurality of holes in the strain relief washer.

12. The thermocouple harness of claim 11, wherein the strain relief washer is configured to be restricted to linear movement along an axis through a center of the front groove of the cylindrical sealant.

13. The thermocouple harness of claim 8, wherein the top tube and the main body are each comprised of a heat resistant alloy.

14. The thermocouple harness of claim 8, wherein:
each hole of the plurality of holes comprises a hole diameter comprising a diameter of a thermocouple of the plurality of thermocouples and a clearance; and
each of the plurality of seals is configured to fill the clearance of the hole diameter at a first side of the hole disposed at the back groove and at a second side of the hole disposed at the front groove.

15. The thermocouple harness of claim 8, wherein a length of the front groove of the cylindrical sealant, a length of the back groove of the cylindrical sealant, and a length of the central portion of the cylindrical sealant are substantially the same.

16. The thermocouple harness of claim 8, wherein a length of the back groove of the cylindrical sealant mitigates heat exposure at the plurality of seals during a coupling process that couples the first end of the cylindrical sealant to the second end of the main body such that the plurality of seals are not structurally compromised by the coupling process.

17. The thermocouple harness of claim 8, wherein:
a length of the front groove of the cylindrical sealant is selected to limit an available bending angle of each of the plurality of thermocouples at the corresponding seal to a threshold angle.

18. The thermocouple harness of claim 8, wherein the putty comprises one of at least ninety percent (90%) alumina and a magnesium oxide base.

19. The thermocouple harness of claim 8, wherein a distance between each pair of the plurality of holes in the cylindrical sealant is at least two times a diameter of one hole of the plurality of holes.

20. The thermocouple harness of claim 8, wherein the solid oxide electrochemical system comprises one of a solid oxide fuel cell system configured to generate electricity and a solid oxide electrolyzer cell system configured to generate a hydrogen product from electrolysis of steam.
